(19) United States
(12) Patent Application Publication
(10) Pub. No.: US 2004/0110477 A1
(43) Pub. Date: Jun. 10, 2004

(54) Apparatus and method for data transmission

(76) Inventors: Hiroshi Nishimura, Kanazawa-shi (JP); Masatoshi Watanabe, Yokohama-shi (JP)

Correspondence Address: STEVENS DAVIS MILLER & MOSHER, LLP, 1615 L STREET, NW, SUITE 850, WASHINGTON, DC, 20036, US

(21) Appl. No.: 10/441,248

(22) Filed: May 20, 2003

(30) Foreign Application Priority Data
May 21, 2002 (JP) 2002-146777

(51) Int. Cl. H04B 7/00

(52) U.S. Cl. 455/127.1; 455/522

(57) ABSTRACT

The adder 203 adds up an average value of the transmit power input from the average processing section 201 and an offset value input from the offset section 202 and sets an upper limit threshold. The subtractor 204 subtracts the offset value input from the offset section 202 from the average value of the transmit power input from the average processing section 201 and sets a lower limit threshold. The comparator 205 compares the transmit power value with the upper limit threshold and outputs the upper limit threshold when the transmit power value is higher than the upper limit threshold and outputs the transmit power value as is when the transmit power value is equal to or lower than the upper limit threshold. Likewise, the comparator 206 compares the transmit power value with the lower limit threshold, outputs the lower limit threshold when the transmit power value is lower than the lower limit threshold and outputs the transmit power value as is when the transmit power value is equal to or higher than the lower limit threshold. This can prevent disconnection of calls and realize a stable communication through appropriate transmit power control even when a wrong signal is received due to deterioration of the communication environment.

### BACKGROUND OF THE INVENTION

1. Field of the Invention

The present invention relates to an apparatus and method for data transmission that controls transmit power.

2. Description of the Related Art

Transmission signals in a CDMA-based wireless communication between a plurality of terminals and a base station constitute interference signals between the terminals, and therefore setting transmit power of the terminals higher than necessary may cause the terminals to interfere with communications with one another. On the other hand, setting transmit power of the terminals lower than necessary may prevent the base station from receiving transmission signals from the communication terminals and cause interruption of the communication (disconnection of calls). Therefore, a CDMA-based wireless communication uses a limit section to set a maximum allowable transmit power value as a limit of transmit power that will not interfere with communications between terminals and a minimum allowable transmit power value as a limit of transmit power that the base station can receive and controls transmit power of both the base station and terminals so that transmission is performed with transmit power between this maximum allowable transmit power value and minimum allowable transmit power value. Furthermore, optimum transmit power for a communication between a terminal and a base station varies from one base station to another depending on its communication environment, and therefore the range between a maximum allowable transmit power value and minimum allowable transmit power value is set to be wide so as to be able to change transmit power to some extent.

However, a conventional data transmission apparatus has a wide range between a maximum allowable transmit power value and minimum allowable transmit power value, and therefore when a wrong signal is received due to deterioration of its communication environment, transmit power may continue to drop down to a minimum allowable transmit power value even when it should originally be increased or transmit power may continue to increase up to a maximum allowable transmit power value even when it can originally be decreased, causing a problem that it is not possible to set appropriate transmit power. Furthermore, transmit power may drop drastically between a maximum allowable transmit power value and minimum allowable transmit power value, and there is a problem that a drastic drop of transmit power causes disconnection of calls.

### SUMMARY OF THE INVENTION

It is an object of the present invention to prevent disconnection of calls and realize a stable communication through appropriate transmit power control even when a wrong signal is received due to deterioration of a communication environment.

This object is attained by setting an upper limit threshold and lower limit threshold calculated from an average transmit power value between a minimum allowable transmit power value and maximum allowable transmit power value, and by transmitting, when the transmit power value is higher than the upper limit threshold or lower than the lower limit threshold, the upper limit threshold or lower limit threshold as the transmit power value.

### BRIEF DESCRIPTION OF THE DRAWINGS

The above and other objects and features of the invention will appear more fully hereinafter from a consideration of the following description taken in connection with the accompanying drawings wherein one example is illustrated by way of example, in which:

FIG. 1 is a block diagram showing a configuration of a data transmission apparatus according to Embodiment 1 of the present invention;

FIG. 2 is a block diagram showing a configuration of a limit section according to Embodiment 1 of the present invention;

FIG. 3 illustrates a relationship between a transmit power value, upper limit threshold and lower limit threshold according to Embodiment 1 of the present invention;

FIG. 4 is a block diagram showing a configuration of a limit section according to Embodiment 2 of the present invention;

FIG. 5 illustrates a relationship between a transmit power value, upper limit threshold and lower limit threshold according to Embodiment 2 of the present invention;

FIG. 6 is a block diagram showing a configuration of a limit section according to Embodiment 3 of the present invention;

FIG. 7 illustrates a relationship between a transmit power value and lower limit threshold according to Embodiment 3 of the present invention;

FIG. 8 is a block diagram showing a configuration of a data transmission apparatus according to Embodiment 4 of the present invention;

FIG. 9 is a block diagram showing a configuration of a limit section according to Embodiment 4 of the present invention;

FIG. 10 illustrates a relationship between a transmit power value, upper limit threshold and lower limit threshold according to Embodiment 4 of the present invention;

FIG. 11 is a block diagram showing a configuration of a data transmission apparatus according to Embodiment 5 of the present invention;

FIG. 12 is a block diagram showing a configuration of a limit section according to Embodiment 5 of the present invention;

FIG. 13 illustrates a relationship between a transmit power value, upper limit threshold and lower limit threshold according to Embodiment 5 of the present invention;

FIG. 14 is a block diagram showing a configuration of a limit section according to Embodiment 6 of the present invention;

FIG. 15 illustrates a relationship between a transmit power value, upper limit threshold and lower limit threshold according to Embodiment 6 of the present invention;

FIG. 16 is a block diagram showing a configuration of a limit section according to Embodiment 7 of the present invention;

FIG. 17 illustrates a relationship between a transmit power value, upper limit threshold and lower limit threshold according to Embodiment 7 of the present invention; and

FIG. 18 illustrates a relationship between a transmit power value, upper limit threshold and lower limit threshold according to Embodiment 7 of the present invention.

### DETAILED DESCRIPTION OF THE PREFERRED EMBODIMENTS

With reference now to the attached drawings, embodiments of the present invention will be explained in detail below.

### Embodiment 1

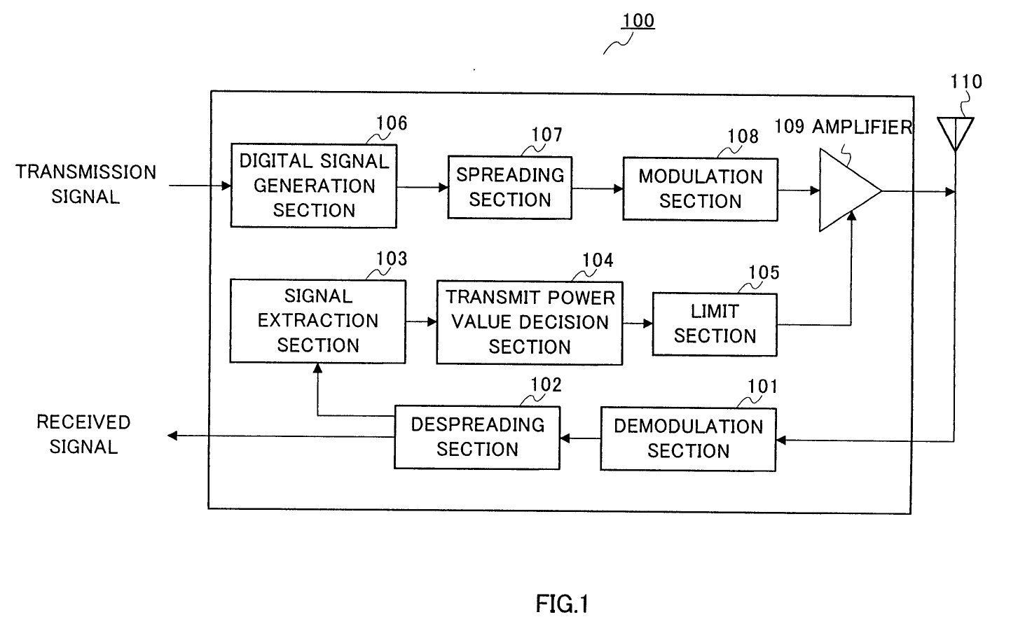

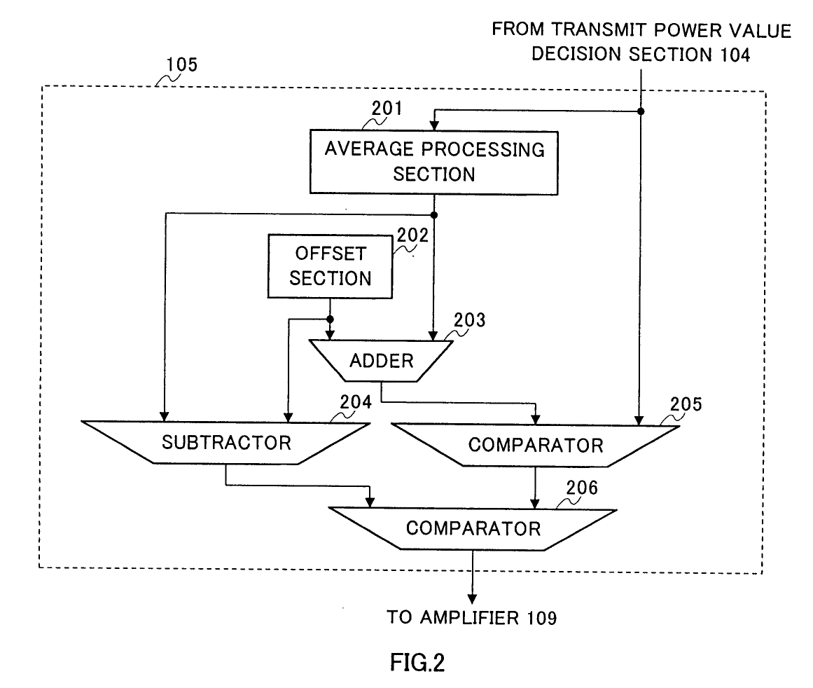

FIG. 1 is a block diagram showing a configuration of a data transmission apparatus 100 according to this embodiment and FIG. 2 is a block diagram showing a configuration of a limit section 105 according to this embodiment. The data transmission apparatus 100 is mainly constructed of a demodulation section 101, a despreading section 102, a signal extraction section 103, a transmit power value decision section 104, a limit section 105, a digital signal generation section 106, a spreading section 107, a modulation section 108, an amplifier 109 and an antenna 110.

The demodulation section 101 performs demodulation processing on a signal received at the antenna 110 and outputs the signal to the despreading section 102.

The despreading section 102 performs despreading processing on the received signal input from the demodulation section 101 to obtain the received signal and outputs the despread received signal to the signal extraction section 103.

The signal extraction section 103 extracts a transmit power control signal (TPC signal) from the received signal input from the despreading section 102 and outputs the signal to the transmit power value decision section 104.

The transmit power value decision section 104 calculates a transmit power value according to the transmit power control signal input from the signal extraction section 103 and outputs the calculated transmit power value to the limit section 105.

The limit section 105 decides whether the transmit power value input from the transmit power value decision section 104 is within a predetermined range or not and places, when the transmit power value is not within the predetermined range, a restriction on the transmit power and outputs a control signal to the amplifier 109. Details of the limit section 105 will be described later.

The digital signal generation section 106 shapes a transmission signal into a digital signal and outputs it to the spreading section 107.

The spreading section 107 performs spreading processing on the digital signal input from the digital signal generation section 106 and outputs it to the modulation section 108.

The modulation section 108 performs modulation processing on the spread signal input from the spreading section 107, modulates the signal to a radio frequency signal and outputs it to the amplifier 109.

The amplifier 109 amplifies the radio frequency signal input from the modulation section 108 so that it has a predetermined transmit power value under the control of the limit section 105 and transmits the amplified radio frequency signal from the antenna 110.

Then, the configuration of the limit section 105 will be explained using FIG. 2. The limit section 105 is mainly constructed of an average processing section 201, an offset section 202, an adder 203, a subtractor 204, a comparator 205 and comparator 206.

The average processing section 201, which is average transmit power value calculating means, is provided with a buffer which is not shown, stores an average transmit power value for a predetermined time calculated by the average processing section 201 in the buffer, adds up the transmit power value input to the average processing section 201 and the average transmit power value stored in the buffer at a predetermined ratio to calculate an average transmit power value (e.g., by adding up the transmit power value and average transmit power value at a ratio of 1:9, it is possible to construct an IIR filter and calculate an average transmit power value) and outputs the calculated average transmit power value to the adder 203 and subtractor 204. The average transmit power value can also be calculated by storing the transmit power value to be input to the average processing section 201 in the buffer every time it is input and outputting the average transmit power value at predetermined time intervals from the average processing section 201.

The offset section 202 sets an offset value from the outside.

The adder 203 as threshold setting means adds up the offset value input from the offset section 202 and the average transmit power value input from the average processing section 201 and outputs the added value to the comparator 205 as the upper limit threshold of the transmit power.

The subtractor 204 uses the average transmit power value input from the average processing section 201 and the offset value input from the offset section 202 to subtract the offset value from the average transmit power value and outputs the subtracted value to the comparator 206 as the lower limit threshold of the transmit power.

The comparator 205 compares the upper limit threshold of the transmit power input from the adder 203 with the transmit power value input from the transmit power value decision section 104 and outputs, when the transmit power value is lower than the upper limit threshold, the transmit power input from the transmit power value decision section 104 to the comparator 206 and outputs, when the transmit power value is equal to or higher than the upper limit threshold, the upper limit threshold input from the adder 203 to the comparator 206.

The comparator 206 compares the value input from the comparator 205 with the lower limit threshold input from the subtractor 204 and outputs, when the value input from the comparator 205 is higher than the lower limit threshold, the value input from the comparator 205 to the amplifier 109 as the transmit power value and outputs, when the value input from the comparator 205 is equal to or lower than the lower limit threshold, the lower limit threshold input from the subtractor 204 to the amplifier 109 as the transmit power value.

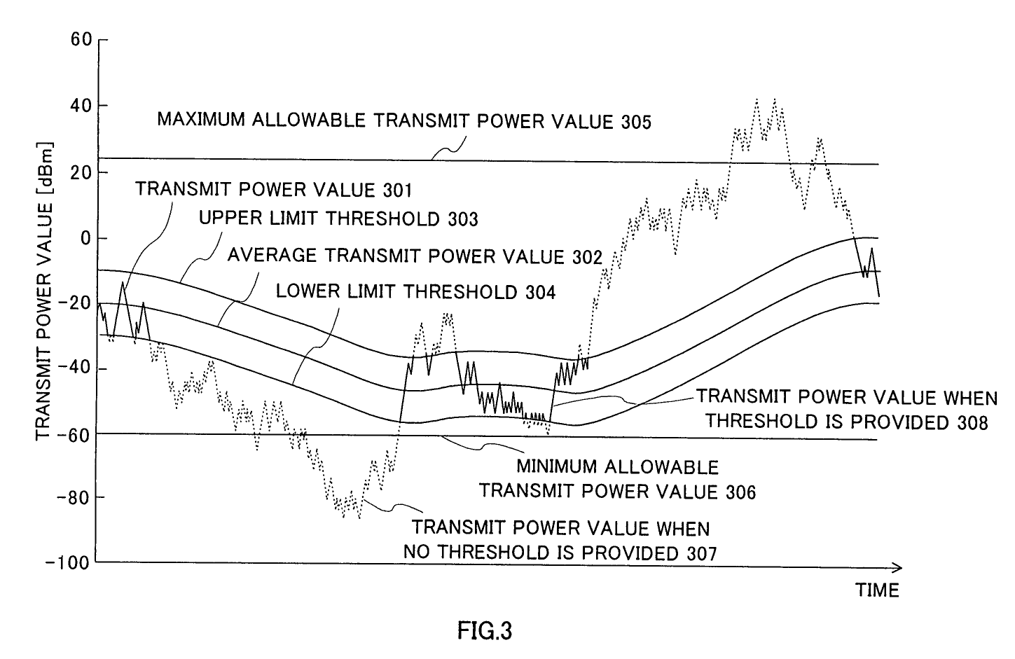

Then, a relationship between the transmit power value, upper limit threshold and lower limit threshold will be explained using FIG. 3. FIG. 3 illustrates a time variation of the transmit power value. The average transmit power value 302 is calculated from the transmit power value 301.

When the transmit power value 301 exceeds the upper limit threshold 303, the upper limit threshold 303 using the transmit power value output to amplifier section 109, and then the average transmit power value 302 is calculated by the transmit power value decided by the transmit power value decision section 104. Furthermore, when the transmit power value 301 falls below the lower limit threshold 304, the lower limit threshold 304 using the transmit power value output to amplifier section 109, and then the average transmit power value 302 is calculated by the transmit power value decided by the transmit power value decision section 104. Therefore, the average transmit power value 302 changes within the range between the maximum allowable transmit power value 305 and the minimum allowable transmit power value 306 and never exceeds the maximum allowable transmit power value 305 or falls below the minimum allowable transmit power value 306.

The upper limit threshold 303 is set at a position between the minimum allowable transmit power value 306 and maximum allowable transmit power value 305 and at the same time the upper limit threshold 303 is higher than the average transmit power value 302 by a predetermined amount. The lower limit threshold 304 is set at a position between the minimum allowable transmit power value 306 and maximum allowable transmit power value 305 and at the same time the lower limit threshold 304 is lower than the average transmit power value 302 by a predetermined amount. The amount of offset from the average transmit power value 302 to the upper limit threshold 303 is set to be the same as the amount of offset from the average transmit power value 302 to the lower limit threshold 304.

In FIG. 3, a dotted line 307 shows a case where the transmit power value 301 decided by the transmit power value decision section 104 exceeds the upper limit threshold 303 or falls below the lower limit threshold 304. A solid line 308 shows a case where the transmit power value 301 decided by the transmit power value decision section 104 changes within the range between the upper limit threshold 303 and the lower limit threshold 304. When the transmit power value 301 is equal to or higher than the upper limit threshold 303 (dotted line 307 in FIG. 3), the transmit power value is set to the upper limit threshold 303 and when the transmit power value 301 is equal to or lower than the lower limit threshold 304 (dotted line 307 in FIG. 3), the transmit power value is set to the lower limit threshold 304.

Transmission with a transmit power value higher than the maximum allowable transmit power value 305 causes interference with other communication terminal apparatuses and transmission with a transmit power value lower than the minimum allowable transmit power value 306 fails to obtain a received signal at a predetermined level, and therefore transmission is normally performed with a transmit power value equal to or lower than the maximum allowable transmit power value 305 and equal to or higher than the minimum allowable transmit power value 306.

However, even when transmission is performed with a transmit power value equal to or lower than the maximum allowable transmit power value 305 and equal to or higher than the minimum allowable transmit power value 306, if the transmit power value drops drastically within this range, disconnection of calls occurs. Therefore, by providing an upper limit threshold 303 and lower limit threshold 304 between the maximum allowable transmit power value 305 and minimum allowable transmit power value 306, the amount of variation of the transmit power value when the transmit power value is decreased within the range between the upper limit threshold 303 and the lower limit threshold 304 is smaller than that when the transmit power value is decreased within the range between the maximum allowable transmit power value 305 and the minimum allowable transmit power value 306, and therefore it is possible to prevent disconnection of calls.

Then, the operation of the data transmission apparatus 100 in the above-described configuration will be explained using FIG. 1 and FIG. 2. First, the operation when the antenna 110 receives a signal will be explained. The signal received at the antenna 110 is input to the demodulation section 101, subjected to demodulation processing, output to the despreading section 102 and subjected to despreading processing at the despreading section 102 to become a received signal.

Then, the case where a transmission signal is transmitted from the antenna 110 and the method of controlling the transmit power value in that case will be explained. The signal extraction section 103 extracts a transmit power control signal (TPC signal) from the received signal input from the despreading section 102, outputs it to the transmit power value decision section 104 and the transmit power value decision section 104 sets a transmit power value according to the transmit power control signal and outputs the set transmit power value to the limit section 105.

The average processing section 201 calculates an average value 302 from the transmit power value 301 input from the transmit power value decision section 104 and outputs the calculated average value 302 to the adder 203 and subtractor 204. Here, since the transmit power value 301 is adjusted to a value between the maximum allowable transmit power value 305 and the minimum allowable transmit power value 306 before it is input to the average processing section 201, the average transmit power value 302 calculated at the average processing section 201 is also a value between the maximum allowable transmit power value 305 and the minimum allowable transmit power value 306. The average transmit power value 302 input from the average processing section 201 to the adder 203 and the offset value input from the offset section 202 to the adder 203 are added up at the adder 203 and output to the comparator 205 as the upper limit threshold 303, compared by the comparator 205 with the transmit power value 301 input from the transmit power value decision section 104. When the transmit power value 301 is lower than the upper limit threshold 303, the comparator 205 outputs the value input from the transmit power value decision section 104 to the comparator 206 and when the transmit power value 301 is equal to or higher than the upper limit threshold 303, the comparator 205 outputs the upper limit threshold 303 input from the adder 203 to the comparator 206.

With the average transmit power value 302 input from the average processing section 201 to the subtractor 204 and the offset value input from the offset section 202 to subtractor 204, the subtractor 204 subtracts the offset value from the average transmit power value 302 and outputs the calculated value to the comparator 206 as the lower limit threshold 304. The lower limit threshold 304 output from the subtraction section 204 to the comparator 206 and the upper limit threshold 303 or transmit power value 301 output from the comparator 205 to the comparator 206 are compared by the comparator 206. When the transmit power value 301 or upper limit threshold 303 input from the comparator 205 is higher than the lower limit threshold 304, the transmit power value 301 or upper limit threshold 303 input from the comparator 205 is regarded as a transmit power value and output to the amplifier 109 as a control signal and when the transmit power value 301 or upper limit threshold 303 input from the comparator 205 is equal to or lower than the lower limit threshold 304, the lower limit threshold 304 is regarded as a transmit power value and output to the amplifier 109 as a control signal. Here, the maximum allowable transmit power value 305 and minimum allowable transmit power value 306 are conventionally set values.

On the other hand, a transmission signal is input to the digital signal generation section 106, converted from an analog signal to a digital signal, output to the spreading section 107 and output to the modulation section 108 as a spread signal. The spread signal is modulated to a radio frequency at the modulation section 108, output to the amplifier 109 and subjected to transmit power control by the limit section 105 at the amplifier 109 and sent from the antenna 110.

In this way, when the transmit power value exceeds the upper limit threshold or falls below the lower limit threshold, this embodiment outputs the upper limit threshold or lower limit threshold as the transmit power value, and can thereby prevent the transmit power from continuing to decrease down to the minimum allowable transmit power value due to reception of a wrong signal when the transmit power should originally be increased and realize appropriate transmit power control. Furthermore, since the upper limit threshold and lower limit threshold are calculated from average power, this embodiment can set the upper limit threshold and lower limit threshold according to the transmit power and perform transmission with appropriate transmit power even when the transmit power exceeds the upper limit threshold or falls below the lower limit threshold. Furthermore, since the range between the upper limit threshold and the lower limit threshold is smaller than the range between the maximum allowable transmit power value and the minimum allowable transmit power value, when the transmit power drops drastically, transmission is performed using the lower limit threshold as the transmit power value, and therefore it is possible to prevent disconnection of calls.

### Embodiment 2

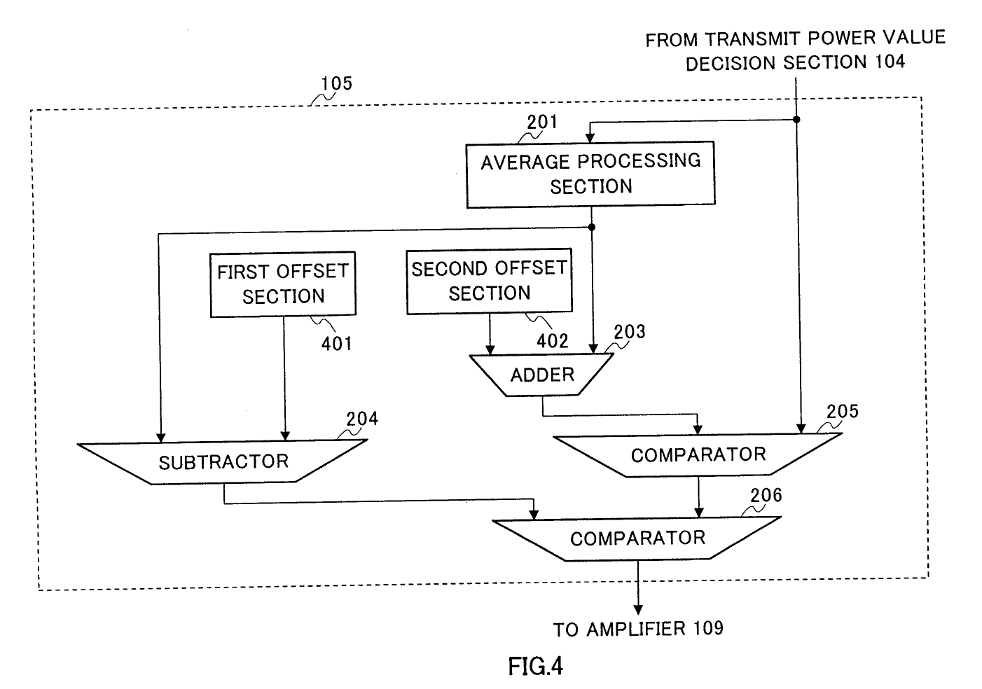

FIG. 4 is a block diagram showing a configuration of a limit section 105 according to Embodiment 2 of the present invention. According to this embodiment, the configuration with a first offset section 401 and a second offset section 402 in FIG. 4 are different from the configuration in FIG. 2 and the rest of the components are the same as those in FIG. 2 and therefore the same components are assigned the same reference numerals and explanations thereof will be omitted. Furthermore, the configuration of the data transmission apparatus is the same as that in FIG. 1 and explanations thereof will be omitted. Furthermore, the operation of the data transmission apparatus other than the limit section 105 is the same as that of Embodiment 1 and explanations thereof will be omitted.

The first offset section 401 is provided from the outside with an offset value to be subtracted from the average transmit power value which is determined based on the transmit power value. The second offset section 402 is provided from the outside with an offset value to be added to the average transmit power value.

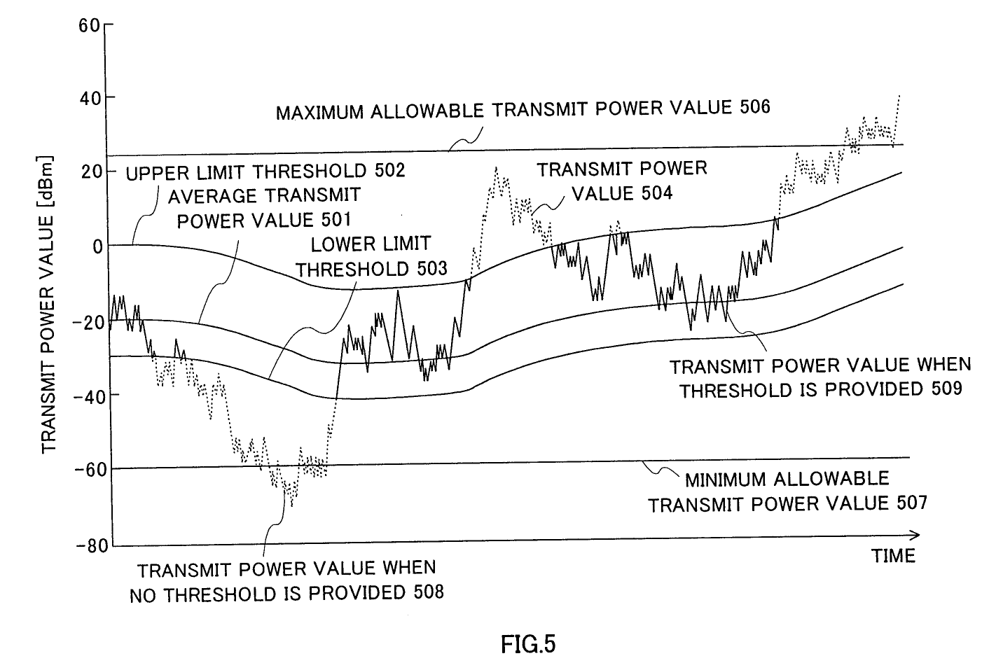

Then, the relationship between the transmit power value, the upper limit threshold and lower limit threshold will be explained using FIG. 5. FIG. 5 illustrates a time variation of the transmit power value. The average transmit power value 501 is obtained from the transmit power value 504.

When the transmit power value 504 exceeds the upper limit threshold 502, the upper limit threshold 502 using the transmit power value output to amplifier section 109, and then the average transmit power value 501 is calculated by the transmit power value determined at the transmit power value decision section 104. When the transmit power value 504 falls below the lower limit threshold 503, the lower limit threshold 503 using the transmit power value output to amplifier section 109, and then the average transmit power value 501 is calculated by the transmit power value determined by the transmit power value decision section 104. Therefore, the average transmit power value 501 varies in the range between the maximum allowable transmit power value 506 and the minimum allowable transmit power value 507 and never exceeds the maximum allowable transmit power value 506 or falls below the minimum allowable transmit power value 507.

The upper limit threshold 502 is set at a position between the minimum allowable transmit power value 507 and the maximum allowable transmit power value 506 and at the same time the upper limit threshold 502 is higher than the average transmit power value 501 by a predetermined amount. On the other hand, the lower limit threshold 503 is set at a position between the minimum allowable transmit power value 507 and the maximum allowable transmit power value 506 and at the same time the lower limit threshold 503 is lower than the average transmit power value 501 by a predetermined amount. The amount of offset from the average transmit power value 501 to the upper limit threshold 502 is set to be different from the amount of offset from the average transmit power value 501 to the lower limit threshold 503.

In FIG. 5, a dotted line 508 shows a case where the transmit power value 504 decided by the transmit power value decision section 104 exceeds the upper limit threshold 502 or falls below the lower limit threshold 503. A solid line 509 shows a case where the transmit power value 504 decided by the transmit power value decision section 104 changes within the range between the upper limit threshold 502 and the lower limit threshold 503. When the transmit power value 504 is equal to or higher than the upper limit threshold 502 (dotted line 508 in FIG. 5), the transmit power value is set to the upper limit threshold 502 and when the transmit power value 504 is lower than the lower limit threshold 503 (dotted line 508 in FIG. 5), the transmit power value is set to the lower limit threshold 503.

Then the operation of the limit section 105 in the above-described configuration will be explained.

The offset value input from the second offset section 402 to the adder 203 and the average transmit power value 501 input from the average processing section 201 to the adder 203 are added up by the adder 203 and output to the comparator 205 as the upper limit threshold 502. On the other hand, with the average transmit power value 501 input from the average processing section 201 to the subtraction section 204 and the offset value input from the first offset section 401 to the subtraction section 204, the subtractor 204 subtracts the offset value from the average transmit power value 501 and outputs to the comparator 206 as the lower limit threshold 503.

Thus, setting a greater value for the second offset section 402 than the first offset section 401 allows the difference between the upper limit threshold 502 and the average transmit power value 501 to be greater than the difference between the lower limit threshold 503 and average transmit power value 501 as shown in FIG. 5. The rest of the operation of the limit section 105 is the same as that of Embodiment 1 and explanations thereof will be omitted.

Thus, in addition to the effect of Embodiment 1 above, this embodiment provides different offset sections for setting an upper limit threshold and lower limit threshold, and therefore it is possible to set the upper limit threshold and lower limit threshold separately and control transmit power flexibly according to a communication environment.

In this embodiment, the offset value of the second offset section 402 is set to be greater than the offset value of the first offset section 401, but it is also possible to set the offset value of the first offset section 401 to be greater than the offset value of the second offset section 402.

### Embodiment 3

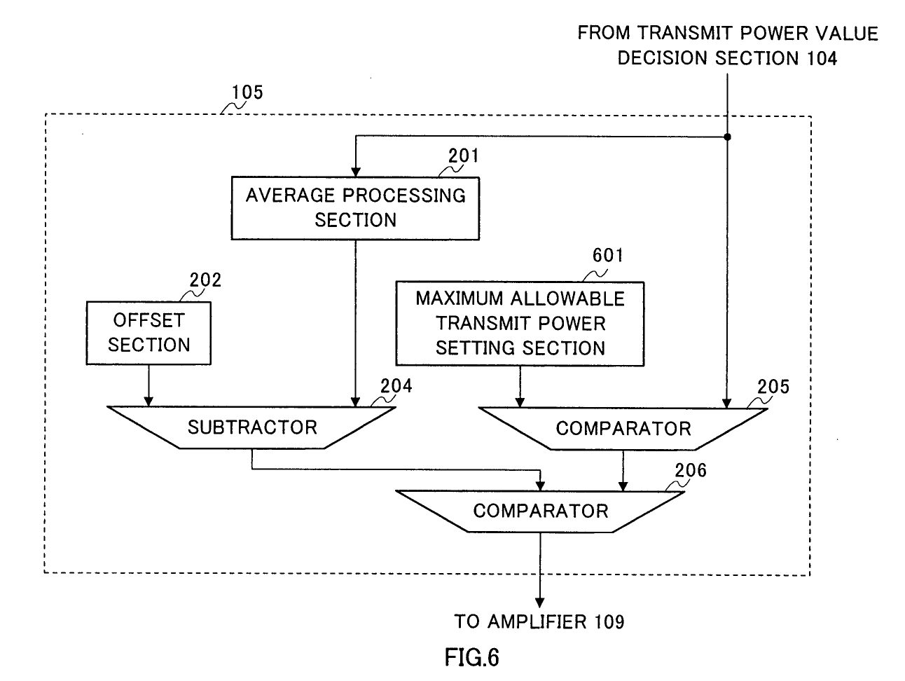

FIG. 6 is a block diagram showing a configuration of a limit section 105 according to Embodiment 3 of the present invention. This embodiment in FIG. 6 differs from FIG. 2 in the configuration provided with a maximum allowable transmit power value setting section 601 instead of the adder 203 and in that there is no input to the maximum allowable transmit power value setting section 601 from the average processing section 201 and offset section 202. The rest of the configuration is the same as that of FIG. 2, and therefore the same components are assigned the same reference numerals and explanations thereof will be omitted. Furthermore, the configuration of the data transmission apparatus is the same as the configuration in FIG. 1 and therefore explanations thereof will be omitted. Furthermore, the operation of the data transmission apparatus other than the limit section is the same as that of Embodiment 1 and therefore explanations thereof will be omitted.

The maximum allowable transmit power value setting section 601 is designed to set transmit power which will not interfere other terminals from the outside and is the same as the conventional maximum allowable transmit power value. The maximum allowable transmit power value set in the maximum allowable transmit power value setting section 601 is output to the comparator 205.

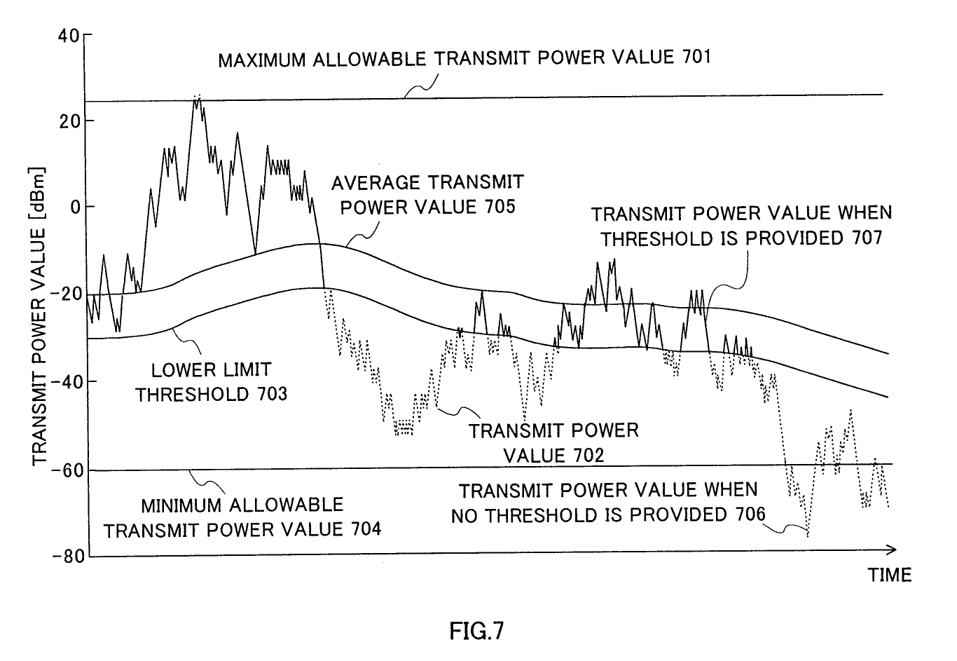

Then, the relationship between the transmit power value and lower limit threshold will be explained using FIG. 7. FIG. 7 illustrates a time variation of the transmit power value. The average transmit power value 705 is obtained from the transmit power value 702. When the transmit power value 705 exceeds the maximum allowable transmit power value 701, the maximum allowable transmit power value 701 using the transmit power value output to amplifier section 109, and then the average transmit power value 705 is calculated by the transmit power value determined at the transmit power value decision section 104. On the other hand, when the transmit power value 702 falls below the lower limit threshold 703, the lower limit threshold 703 using the transmit power value output to amplifier section 109, and then the average transmit power value 705 is calculated by the transmit power value determined by the transmit power value decision section 104. Therefore, the average transmit power value 705 varies in the range between the maximum allowable transmit power value 701 and the minimum allowable transmit power value 704 and never exceeds the maximum allowable transmit power value 701 or falls below the minimum allowable transmit power value 704.

The lower limit threshold 703 is set at a position between the minimum allowable transmit power value 704 and the maximum allowable transmit power value 701 and at the same time the lower limit threshold 703 is lower than the average transmit power value 705 by a predetermined amount.

In FIG. 7, a dotted line 702 shows a case where the transmit power value 702 decided by the transmit power value decision section 104 exceeds the maximum allowable transmit power value 701 or falls below the lower limit threshold 703. A solid line 707 shows a case where the transmit power value 702 decided by the transmit power value decision section 104 changes within the range between the maximum allowable transmit power value 701 and the lower limit threshold 703. When the transmit power value 702 is equal to or higher than the maximum allowable transmit power value 701 (dotted line 702 in FIG. 7), the transmit power value is set to the maximum allowable transmit power value 701 and when the transmit power value 702 is equal to or lower than the lower limit threshold 703 (dotted line 702 in FIG. 7), the transmit power value is set to the lower limit threshold 703.

Then the operation of the limit section 105 in the above-described configuration will be explained using FIG. 7.

The maximum allowable transmit power value 701 input from the maximum allowable transmit power value setting section 601 to the comparator 205 and the transmit power value 702 input from the transmit power value decision section 104 to the comparator 205 are compared by the comparator 205. The comparator 205 outputs the transmit power 702 to the comparator 206 when the transmit power 702 is lower than the maximum allowable transmit power value 701 and outputs the maximum allowable transmit power value 701 to the comparator 206 when the transmit power value 702 is equal to or higher than the maximum allowable transmit power value 701. The comparator 206 compares the maximum allowable transmit power value 701 or transmit power value 702 input from the comparator 205 with the lower limit threshold 703 input from the subtractor 204 and when the maximum allowable transmit power value 701 or transmit power value 702 is higher than the lower limit threshold 703, it outputs the maximum allowable transmit power value 701 or transmit power value 702 to the amplifier 109 as the transmit power value and when the maximum allowable transmit power value 701 or transmit power value 702 is equal to or lower than the lower limit threshold 703, it outputs the lower limit threshold 703 input from the subtractor 204 to the amplifier 109 as the transmit power.

Thus, this embodiment outputs, when the transmit power value is equal to or lower than the lower limit threshold 703, the lower limit threshold 703 as the transmit power value, and can thereby prevent the transmit power from continuing to decrease down to the minimum allowable transmit power value 704 when the transmit power should originally be increased due to reception of a wrong signal and control transmit power appropriately. Furthermore, since the lower limit threshold 703 is calculated from the average transmit power value 705, it is possible to set the lower limit threshold 703 according to the transmit power value 702 and perform transmission with appropriate transmit power even when the transmit power 702 falls below the lower limit threshold 703. Furthermore, since the lower limit threshold 703 is set to a transmit power value higher than the minimum allowable transmit power value 704, it is possible to perform transmission using the lower limit threshold 703 as the transmit power value when the transmit power drops drastically and prevent disconnection of calls. Furthermore, since only the lower limit threshold 703 is set, it is possible to simplify the configuration of the limit section.

This embodiment sets only the lower limit threshold 703, but this embodiment can also be adapted so as to set only the upper limit threshold. In this case, a minimum allowable transmit power value setting section is provided instead of the maximum allowable transmit power value setting section 601 and an adder is provided instead of the subtractor 204 in FIG. 6.

### Embodiment 4

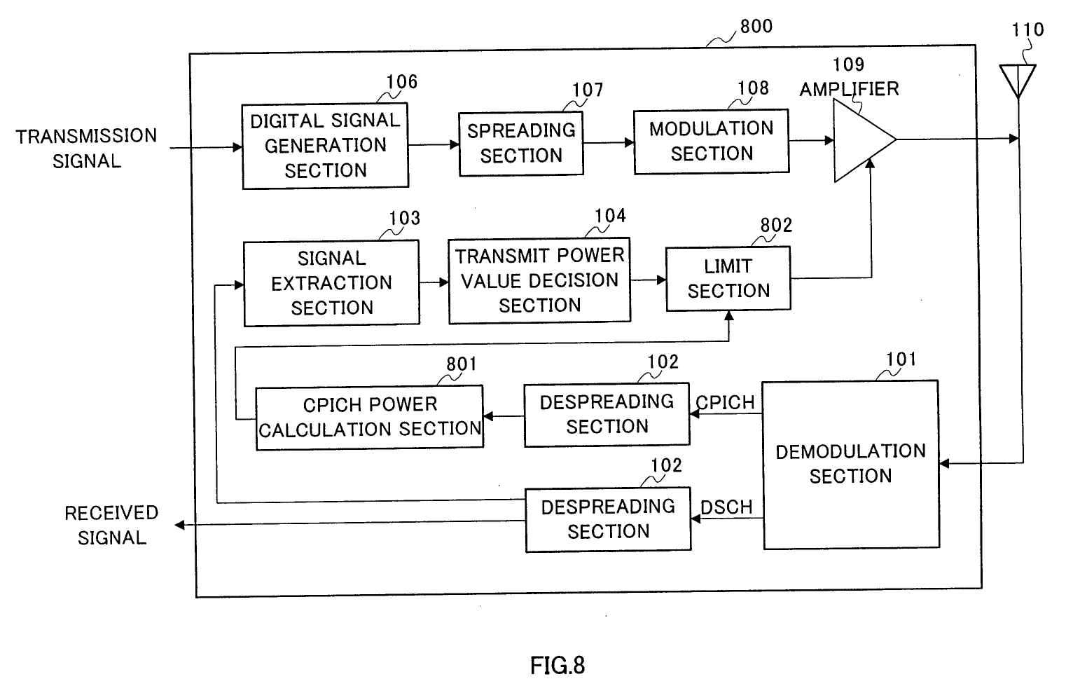

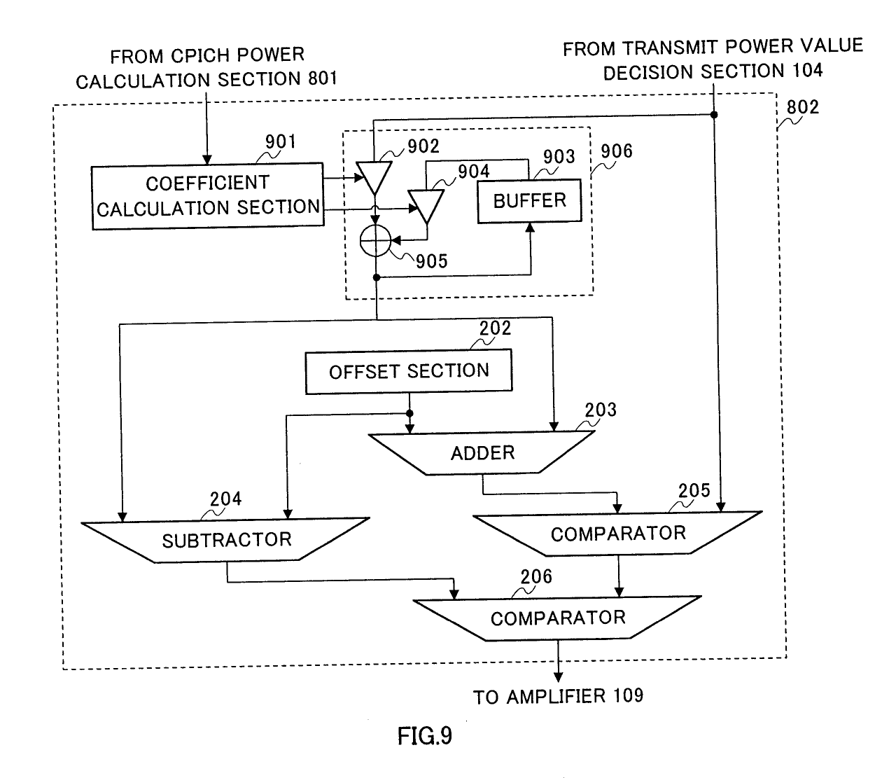

FIG. 8 is a block diagram showing a configuration of a data transmission apparatus 800 according to Embodiment 4 of the present invention and FIG. 9 is a block diagram showing a configuration of a limit section 802 according to Embodiment 4. This embodiment differs from FIG. 1 in the configuration in FIG. 8 including a CPICH (Common Pilot Channel) power calculation section 801 and differs from FIG. 2 in the configuration in FIG. 9 including a coefficient calculation section 901 and the internal configuration of an average processing section 906, but the rest of the components are the same as those of FIG. 1 or FIG. 2, and therefore those components are assigned the same reference numerals and explanations thereof will be omitted.

The CPICH power calculation section 801 calculates a CPICH reception power value from a CPICH received signal, which has been received from an antenna 110, demodulated by a demodulation section 101 and subjected to despreading processing by a despreading section 102, and outputs the CPICH reception power value to a limit section 802.

Then, the configuration of the limit section 802 will be explained.

The average processing section 906 is mainly constructed of a coefficient multiplier 902, a buffer 903, a coefficient multiplier 904 and an adder 905.

When the CPICH reception power value input from the CPICH power calculation section 801 is high level, the coefficient calculation section 901 sets a large value as coefficient α of the coefficient multiplier 902 and when the CPICH reception power value input from the CPICH power calculation section is low level, it sets a small value as the coefficient α of the coefficient multiplier 902 and outputs the set coefficient α to the coefficient multiplier 902. Furthermore, the coefficient calculation section 901 sets a coefficient (1-α) of the coefficient multiplier 904 from the coefficient α of the coefficient multiplier 902 and outputs the set coefficient (α-1) to the coefficient multiplier 904. The coefficient α of the coefficient multiplier 902 is set to a value from 0 to 1.

The coefficient multiplier 902 multiplies the transmit power value by the coefficient α with the value set from the coefficient calculation section 901 and outputs it to the adder 905.

The buffer 903 as a storage section stores the previous average transmit power value output from the adder 905 and outputs it to the coefficient multiplier 904.

The coefficient multiplier 904 multiplies the previous transmit power value by the coefficient (1-α) set from the coefficient calculation section 901 and outputs it to the adder 905.

The adder 905 adds up the transmit power output from the coefficient multiplier 902 and the coefficient multiplier 904 and outputs the added value to the adder 203, subtractor 204 and buffer 903.

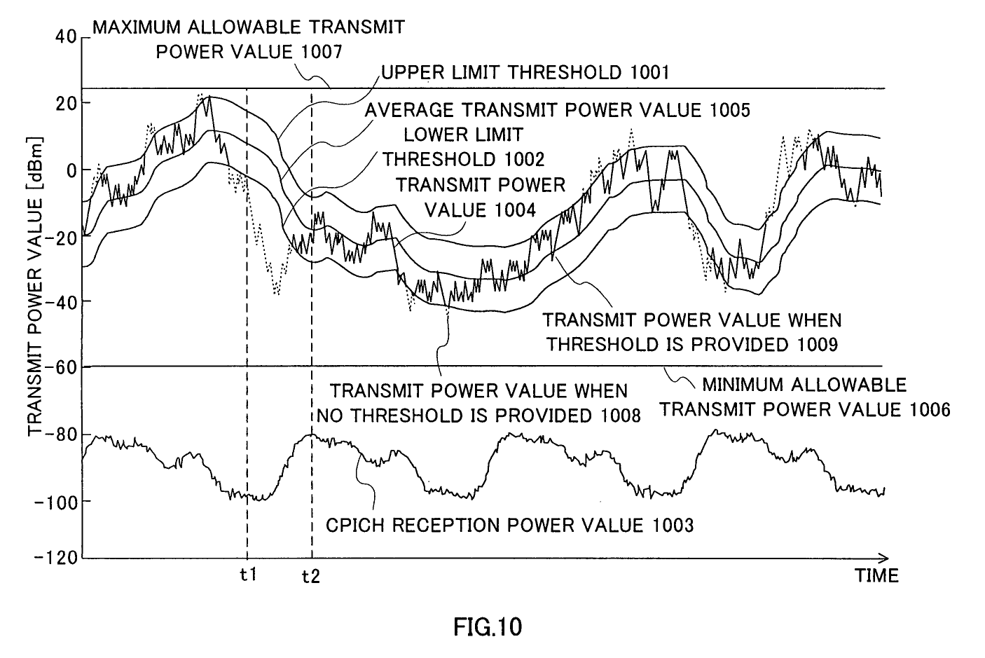

Then, the relationship between the transmit power value, upper limit threshold and lower limit threshold will be explained using FIG. 10. FIG. 10 shows a time variation of the transmit power value. The average transmit power value 1005 is obtained from the transmit power value 1004.

When the transmit power value 1004 exceeds the upper limit threshold 1001, the upper limit threshold 1001 using the transmission power value, and then the average transmit power value 1005 is calculated by the transmit power value determined at the transmit power value decision section 104. When the transmit power value 1004 falls below the lower limit threshold 1002, the lower limit threshold 1002 using transmission power value, and then the average transmit power value is calculated by the transmit power value determined by the transmit power value decision section 104. Therefore, the average transmit power value 1005 varies in the range between the maximum allowable transmit power value 1007 and the minimum allowable transmit power value 1006 and never exceeds the maximum allowable transmit power value 1007 or falls below the minimum allowable transmit power value 1006.

The upper limit threshold 1001 is set at a position between the minimum allowable transmit power value 1006 and the maximum allowable transmit power value 1007 and at the same time the upper limit threshold 1001 is higher than the average transmit power value 1005 by a predetermined amount. Furthermore, the lower limit threshold 1002 is set at a position between the minimum allowable transmit power value 1006 and the maximum allowable transmit power value 1007 and at the same time the lower limit threshold 1002 is lower than the average transmit power value 1005 by a predetermined amount.

At time t1, the CPICH reception power value 1003 is low level, and therefore the average processing section 906 increases a weight of the previous average transmit power value stored in the buffer 903 and outputs it as an optimum average transmit power value 1005. Furthermore, at time t2, the CPICH reception power value 1003 is high level, and therefore the average processing section 906 decreases the weight of the previous average transmit power value stored in the buffer 903 and outputs it as an optimum average transmit power value 1005. For this reason, the amount of variation per unit time of the average transmit power value 1005 after the time t2 is greater than the amount of variation per unit time of the average transmit power value 1005 from t1 to t2.

In FIG. 10, a dotted line 1008 shows a case where the transmit power value 1004 decided by the transmit power value decision section 104 exceeds the upper limit threshold 1001 or falls below the lower limit threshold 1002. A solid line 1009 shows a case where the transmit power value 1004 decided by the transmit power value decision section 104 changes within the range between the upper limit threshold 1001 and the lower limit threshold 1002. When the transmit power value 1004 is equal to or higher than the upper limit threshold 1001 (dotted line 1008 in FIG. 10), the transmit power value is set to the upper limit threshold 1001 and when the transmit power value 1004 is equal to or lower than the lower limit threshold 1002 (dotted line 1008 in FIG. 10), the transmit power value is set to the lower limit threshold 1002.

Then the operation of the data transmission apparatus 800 in the above-described configuration will be explained using FIG. 8 to FIG. 10. The CPICH signal received from the antenna 110 is demodulated by the demodulation section 101, output to the despreading section 102, subjected to despreading processing, output to the CPICH power calculation section 801 and the CPICH power calculation section 801 calculates a CPICH reception power value 1003. The CPICH reception power value 1003 calculated by the CPICH power calculation section 801 is output to the coefficient calculation section 901 of the limit section 802. When the CPICH reception power value 1003 input from the CPICH power calculation section 801 to the coefficient calculation section 901 is high level, the coefficient calculation section 901 sets a large value as the coefficient α of the coefficient multiplier 902 and when the CPICH reception power value 1003 input from the CPICH power calculation section 801 to the coefficient calculation section 901 is low level, the coefficient calculation section 901 sets a small value as the coefficient α of the coefficient multiplier 902. Furthermore, the coefficient calculation section 901 calculates a coefficient (1-α) of the coefficient multiplier 904 from the coefficient α of the set coefficient multiplier 902. The transmit power value 1004 input to the coefficient multiplier 902 is multiplied by the coefficient α at the coefficient multiplier 902 and output to the adder 905.

On the other hand, the buffer 903 stores an optimum average transmit power value 1005 which is a previous output from the adder 905 and the previous average transmit power value output from the buffer 903 to the coefficient multiplier 904 is multiplied by a coefficient (1-α) at the coefficient multiplier 904 and output to the adder 905. The transmit power value 1004 output from the coefficient multiplier 902 to the adder 905 and the previous average transmit power value 1005 output from the coefficient multiplier 904 to the adder 905 are added up at the adder 905, output to the subtractor 204 and adder 203 as the optimum average transmit power value 1005 and at the same time output to the buffer 903. The average processing section 906 controls the coefficient α in this way and decreases the ratio of the average transmit power value output from the buffer 903 when the CPICH reception power value 1003 is high level and outputs the transmit power value same as or close to the transmit power value input from transmit power value decision section 104 as the average transmit power value, and when the CPICH reception power value 1003 is low level, it increases the ratio of the previous average transmit power value output from the buffer 903 and outputs it as the optimum average transmit power value. Therefore, it is possible to calculate the optimum average transmit power value 1005 at the optimum ratio according to the CPICH reception power value 1003. The rest of the operation is the same as that in Embodiment 1 and explanations thereof will be omitted.

In this way, in addition to the effect of Embodiment 1 above, this embodiment increases the weight of the transmit power to be input from transmit power value decision section 104 when the CPICH reception power value 1003 is high level and increases the weight of the transmit power stored in the buffer 903 when the CPICH reception power value 1003 is low level, adds up the current transmit power value 1004 to be input from transmit power value decision section 104 and the previous average transmit power value stored in the buffer 903 at a optimum ratio according to the CPICH power value to provide the previous average transmit power value, and can thereby suppress the variation of the optimum average transmit power value 1005 and realize a stable communication even when the CPICH reception power value 1003 increases or decreases drastically.

### Embodiment 5

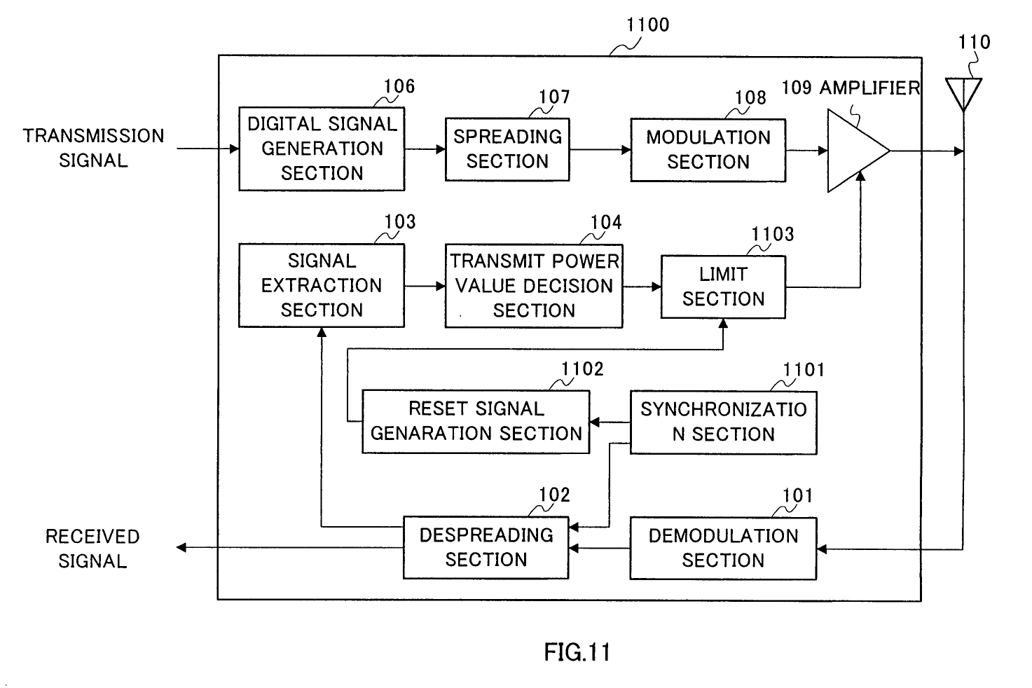

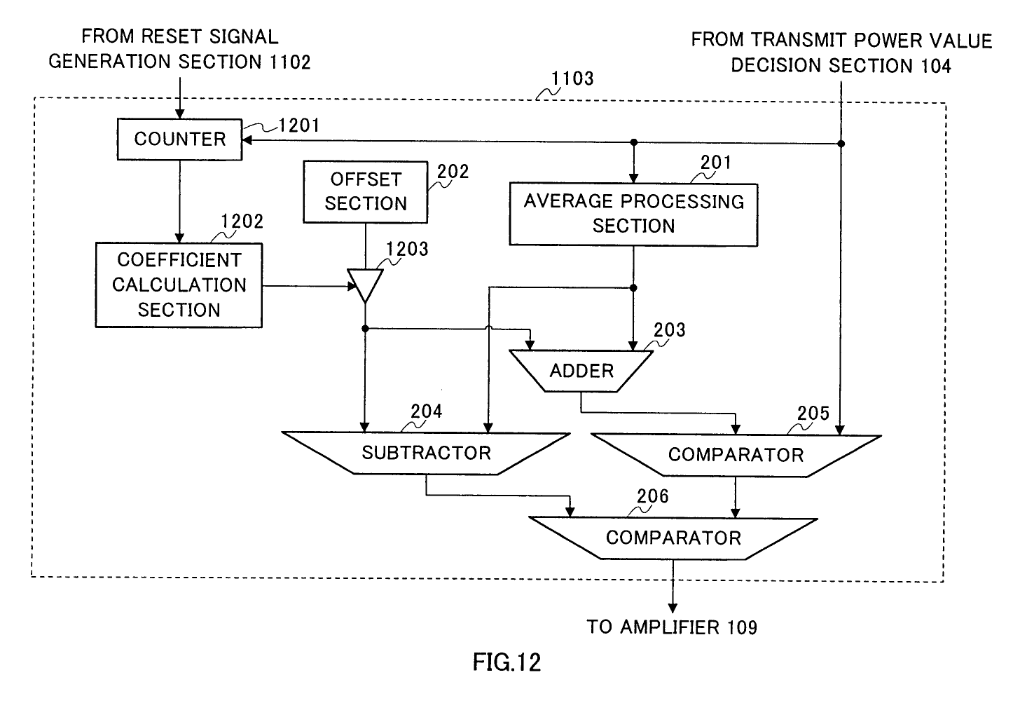

FIG. 11 is a block diagram showing a configuration of a data transmission apparatus 1100 according to Embodiment 5 of the present invention and FIG. 12 is block diagram showing a configuration of a limit section 1103. This embodiment differs from FIG. 1 in the configuration in FIG. 11 including a synchronization section 1101 and reset signal generation section 1102 and the configuration in which a signal is output from the reset signal generation section 1102 to the limit section 1103, but the rest of the components are the same as those of FIG. 1, and therefore those components are assigned the same reference numerals and explanations thereof will be omitted. Furthermore, FIG. 12 differs from FIG. 2 in the configuration including a counter 1201, a coefficient calculation section 1202 and a coefficient multiplier 1203, but the rest of the components are the same as those of FIG. 2, and therefore those components are assigned the same reference numerals and explanations thereof will be omitted.

First, the configuration of the data transmission apparatus 1100 will be explained. The synchronization section 1101 establishes synchronization with the demodulated received signal input from a demodulation section 101 and outputs the synchronized signal to the despreading section 102 and reset signal generation section 1102.

The reset signal generation section 1102 monitors the synchronized signal from the synchronization section 1101 and there by detects whether a base station (not shown) which is a transmission source has been switched to a different base station due to handover and if the base station has been switched, the reset signal generation section 1102 outputs a reset signal to a limit section 1103.

Then, the configuration of the limit section 1103 will be explained. The counter 1201 increments a value in the counter 1201 by 1 and outputs the value in the counter 1201 to the coefficient calculation section 1202 every time the input value of the transmit power changes. When the reset signal is input from the reset signal generation section 1102, the counter 1201 further initializes the value in the counter 1201 to 0 and outputs 0 to the coefficient calculation section 1202.

When 0 is input from the counter 1201, the coefficient calculation section 1202 sets the value of coefficient β of the coefficient multiplier 1203 to a maximum value and sets the value so that the coefficient β of the coefficient multiplier 1203 decreases every time the value input from the counter 1201 increases from 0. When the value input from the counter 1201 becomes equal to or higher than a certain value, the coefficient calculation section 1202 performs processing to fix the coefficient β of the coefficient multiplier 1203 to a certain value so that it does not continue to fall below that value. The relationship between the input value from the counter 1201 and coefficient β is set according to a method of creating a reference table beforehand or calculating it by a numerical expression, etc.

The coefficient multiplier 1203 multiplies the offset value output from the offset section 202 by the coefficient β controlled by the coefficient calculation section 1202 and outputs the calculation result to the adder 203 and subtractor 204.

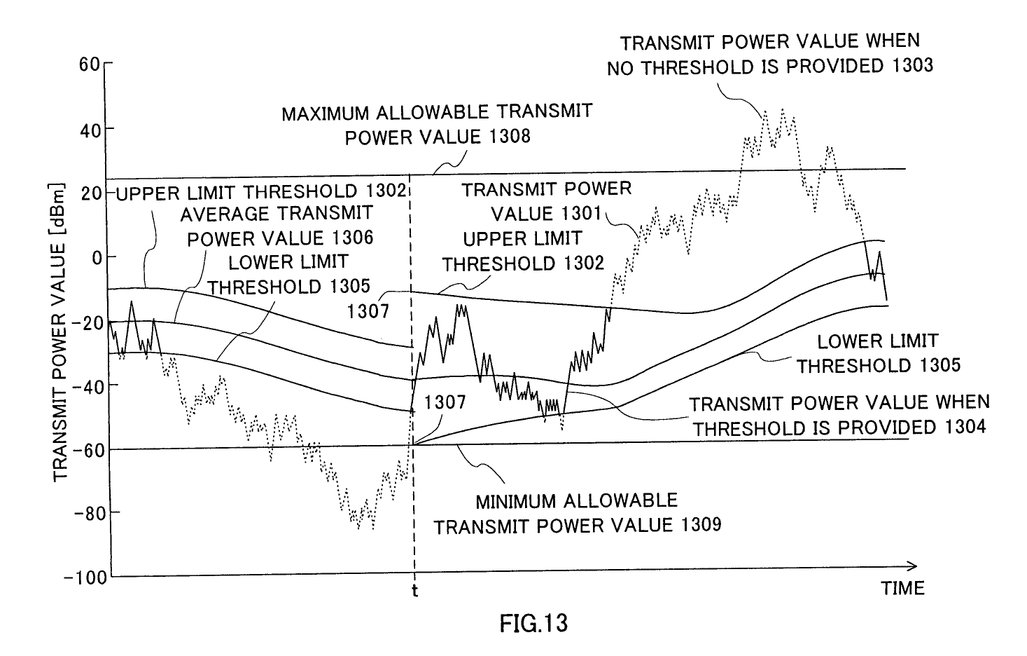

A relationship between the transmit power value, upper limit threshold and lower limit threshold will be explained using FIG. 13. FIG. 13 shows a time variation of the transmit power value. The average transmit power value 1306 is obtained from the transmit power value 1301.

When the transmit power value 1301 exceeds the upper limit threshold 1302, the upper limit threshold 1302 using the transmit power value, and then the average transmit power value 1306 is calculated by the transmit power value determined at the transmit power value decision section 104. When the transmit power value 1301 falls below the lower limit threshold 1305, the lower limit threshold 1305 using the transmit power value, and then the average transmit power value 1306 is calculated by the transmit power value determined by the transmit power value decision section 104. Therefore, the average transmit power value 1306 varies in the range between the maximum allowable transmit power value 1308 and the minimum allowable transmit power value 1309 and never exceeds the maximum allowable transmit power value 1308 or falls below the minimum allowable transmit power value 1309.

The upper limit threshold 1302 is set at a position between the minimum allowable transmit power value 1309 and the maximum allowable transmit power value 1308 and at the same time the upper limit threshold 1302 is higher than the average transmit power value 1306 by a predetermined amount. Furthermore, the lower limit threshold 1305 is set at a position between the minimum allowable transmit power value 1309 and the maximum allowable transmit power value 1308 and at the same time the lower limit threshold 1305 is lower than the average transmit power value 1306 by a predetermined amount. Through transmit power control by the limit section 1103, the transmit power value is set to the range between the upper limit threshold 1302 and the lower limit threshold 1305.

In FIG. 13, a dotted line 1303 shows a case where the transmit power value 1301 decided by the transmit power value decision section 104 exceeds the upper limit threshold 1302 or falls below the lower limit threshold 1305. A solid line 1304 shows a case where the transmit power value 1301 decided by the transmit power value decision section 104 changes within the range between the upper limit threshold 1302 and the lower limit threshold 1305. When the transmit power value 1301 is equal to or higher than the upper limit threshold 1302 (dotted line 1303 in FIG. 13), the transmit power value is set to the upper limit threshold 1302 and when the transmit power value 1301 is equal to or lower than the lower limit threshold 1305 (dotted line 1303 in FIG. 13), the transmit power value is set to the lower limit threshold 1305.

Then, the operation of the data transmission apparatus 1100 will be explained using a case where the data transmission apparatus 1100 is applied to a communication terminal apparatus and the communication terminal apparatus carries out a communication with a base station as an example using FIG. 11 to FIG. 13. First, a case where a signal is received will be explained.

The synchronization section 1101 establishes synchronization with the received signal input from a demodulation section 101 and outputs the synchronized signal to the despreading section 102 and reset signal generation section 1102. When the synchronization section 1101 detects that the base station with which the terminal communicates is changed due to handover at a time t shown in FIG. 13, the synchronization section 1101 outputs information that the base station has been changed to the reset signal generation section 1102 and the reset signal generation section 1102 outputs a reset signal to the counter 1201 of the limit section 1103. At this time, when the base station at the handover destination requests the terminal to send a signal with higher transmit power than that of the base station which is the handover source, if the upper limit threshold 1302 which has been set so far is kept, the limit section 1103 will not allow signals with transmit power equal to or higher than the upper limit threshold 1302 to be sent. Therefore, the reset signal generation section 1102 outputs a reset signal to the counter 1201 and carries out processing for widening the range between the upper limit threshold and average transmit power value and the range between the lower limit threshold and average transmit power value at a stroke. The operation for widening this difference will be explained below.

The counter 1201 to which the reset signal is input sets the internal value to 0, outputs the set value 0 to the coefficient calculation section 1202 and the coefficient calculation section 1202 sets a value in the coefficient multiplier 1203 so that the value of the coefficient β reaches a maximum. The offset value output from the offset section 202 is multiplied by the coefficient β at the coefficient multiplier 1203 and output to the adder 203 and subtractor 204. Since the value of the coefficient β of the coefficient multiplier 1203 reaches a maximum immediately after the base station is changed at the time t, the offset value output from the offset section 202 also reaches a maximum and the maximum offset value is output from the coefficient multiplier 1203 to the adder 203 and subtractor 204, and therefore the upper limit threshold 1302 and lower limit threshold 1305 are set to the initial power value 1307 where the range between the upper limit threshold 1302 and average transmit power value 1306 and the range between the lower limit threshold 1305 and average transmit power value 1306 reach a maximum.

After the value of the counter 1201 is reset to 0, the counter 1201 increments the value of the counter 1201 by 1 every time the input value of the transmit power changes and outputs the value of the counter 1201 to the coefficient calculation section 1202. Then, the coefficient calculation section 1202 reduces the coefficient β of the coefficient multiplier 1203 every time the value input from the counter 1201 is increased. As the coefficient β decreases, the upper limit threshold 1302 and lower limit threshold 1305 gradually approach the average transmit power value 1306 so that the range between the upper limit threshold 1302 and average transmit power value 1306 and the range between the lower limit threshold 1305 and average transmit power value 1306 which have reached a maximum at the time t decrease with time. Then, when the value input from the counter 1201 to the coefficient calculation section 1202 reaches a predetermined value, the coefficient β is fixed so that the value of the coefficient β of the coefficient multiplier 1203 does not continue to fall below that value. When the value of β is fixed, the offset value input from the coefficient multiplication section 1203 to the adder 203 and subtractor 204 does not change, and therefore the upper limit threshold 1302 and lower limit threshold 1305 are positions closer to the average transmit power value 1306 than the initial power value 1307, fixed at a final power value where the range between the upper limit threshold 1302 and average transmit power value 1306 and the range between the lower limit threshold 1305 and average transmit power value 1306 become constant and does not approach the average transmit power value 1306 more than the final power value. The rest of the operation is the same as that in Embodiment 1 above and therefore explanations thereof will be omitted.

In this way, when transmit power changes, this embodiment maximizes the offset value output from the offset section 202 and widens the range between the upper limit threshold 1302 and lower limit threshold 1305, and can thereby the quickly increase transmit power up to the required transmit power value and realize a stable communication.

This embodiment has explained the case where the transmit power is increased by changing the base station, but the present invention is not limited to this and is also applicable to a case where the transmit power is decreased by changing the base station. Furthermore, this embodiment has explained the case where transmit power changes when the base station is changed, but the present invention is not limited to this and is also applicable to a case where transmit power changes for reasons other than that the base station apparatus is changed.

### Embodiment 6

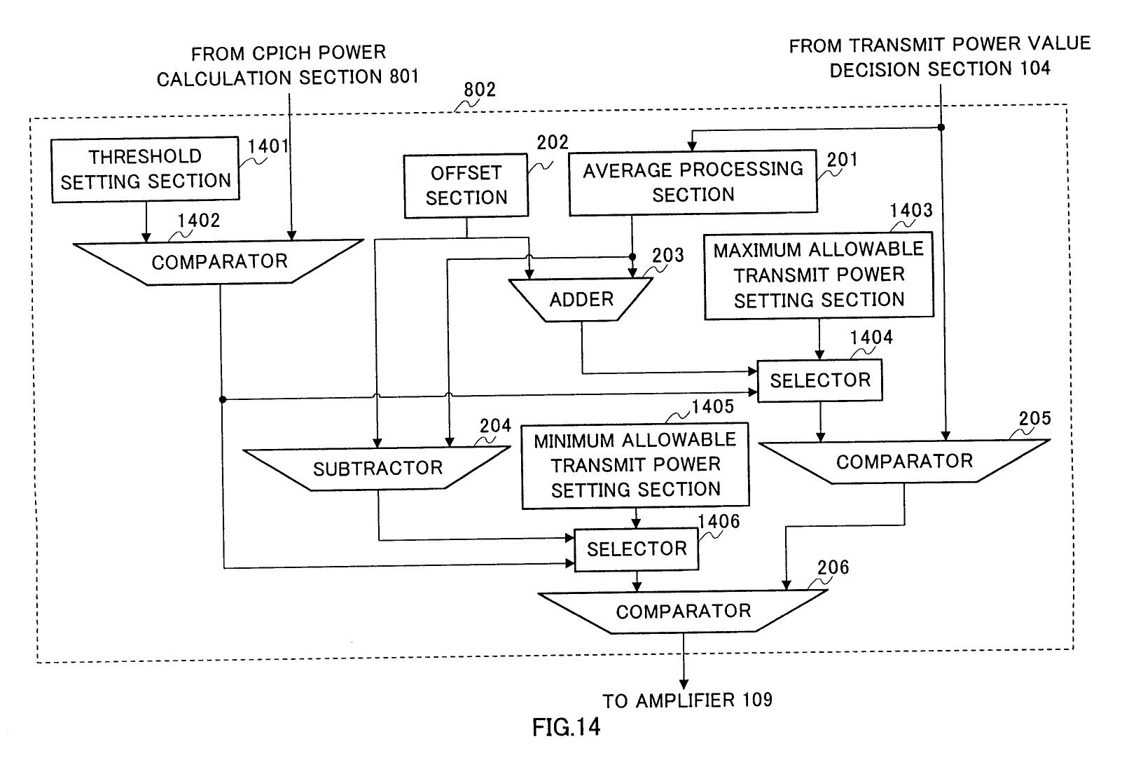

FIG. 14 is a block diagram showing a configuration of a limit section 802 according to Embodiment 6 of the present invention. This embodiment in FIG. 14 differs from the configuration in FIG. 2 in the configuration including a threshold setting section 1401, a comparator 1402, a maximum allowable transmit power value setting section 1403, a selector 1404, a minimum allowable transmit power value setting section 1405 and a selector 1406 and the rest of the components of the data transmission apparatus and the limit section are the same as the components in FIG. 8 and FIG. 2 and therefore those components are assigned the same reference numerals and explanations thereof will be omitted. Moreover, the operation of the data transmission apparatus other than that of the limit section 802 is the same as that in Embodiment 4 and explanations thereof will be omitted.

The threshold setting section 1401 sets a first threshold and outputs the set first threshold to the comparator 1402.

The comparator 1402 compares a CPICH reception power value input from the CPICH power calculation section 801 with the first threshold input from the threshold setting section 1401 and outputs the comparison result to the selector 1404 and selector 1406.

The maximum allowable transmit power value setting section 1403 sets a maximum allowable transmit power value and outputs the set maximum allowable transmit power value to the selector 1404.

Upon receipt of a comparison result that the CPICH reception power value is smaller than the first threshold from the comparator 1402, the selector 1404 selects the output of the adder 203 and outputs it to the comparator 205. On the other hand, upon receipt of a comparison result that the CPICH reception power value is equal to or greater than the first threshold from the comparator 1402, the selector 1404 selects the output of the maximum allowable transmit power value setting section 1403 and outputs it to the comparator 205.

The minimum allowable transmit power value setting section 1405 sets a minimum allowable transmit power value and outputs the set minimum allowable transmit power value to the selector 1406.

Upon receipt of a comparison result that the CPICH reception power value is smaller than the first threshold from the comparator 1402, the selector 1406 selects the output of the subtractor 204 and outputs it to the comparator 206. On the other hand, upon receipt of a comparison result that the CPICH reception power value is equal to or greater than the first threshold from the comparator 1402, the selector 1406 selects the output of the minimum allowable transmit power value setting section 1405 and outputs it to the comparator 206.

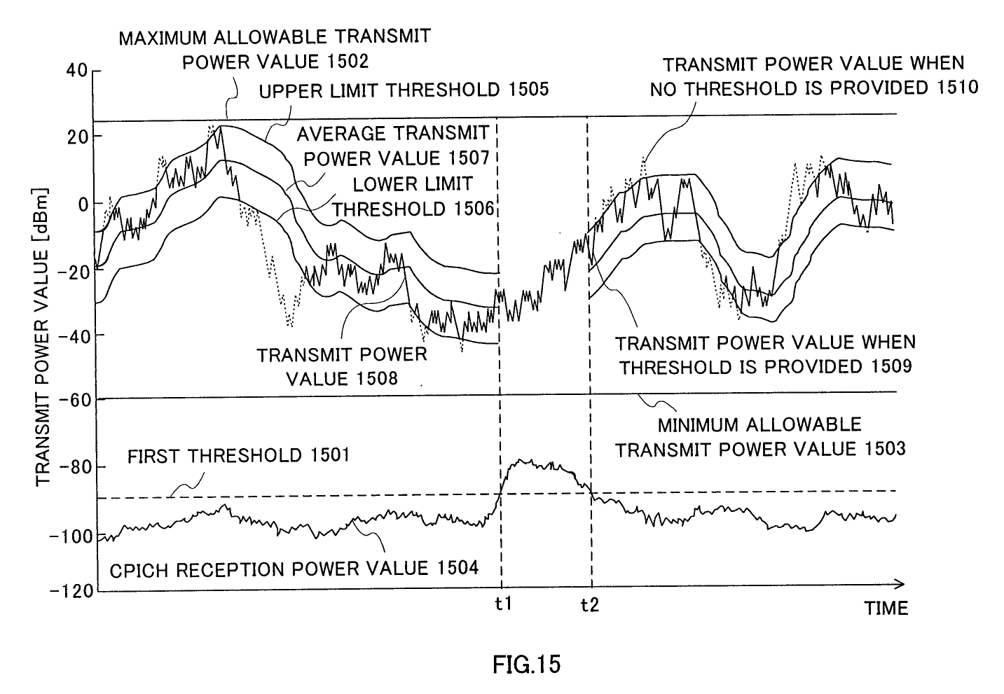

Then, a relationship between a transmit power value, upper limit threshold and lower limit threshold will be explained using FIG. 15. FIG. 15 shows a time variation of a transmit power value. The average transmit power value 1507 is obtained from the transmit power value 1508.

When the transmit power value 1508 exceeds the upper limit threshold 1505, the upper limit threshold using the transmit power value, and then the average transmit power value 1507 is calculated by the transmit power value determined at the transmit power value decision section 104. When the transmit power value 1508 falls below the lower limit threshold 1506, the lower limit threshold using the transmit power value, and then the average transmit power value 1507 is calculated by the transmit power value determined by the transmit power value decision section 104. Therefore, the average transmit power value 1507 varies in the range between the maximum allowable transmit power value 1502 and the minimum allowable transmit power value 1503 and never exceeds the maximum allowable transmit power value 1502 or falls below the minimum allowable transmit power value 1503.

The upper limit threshold 1505 is set at a position between the minimum allowable transmit power value 1503 and the maximum allowable transmit power value 1502 and at the same time the upper limit threshold 1505 is higher than the average transmit power value 1507 by a predetermined amount. Furthermore, the lower limit threshold 1506 is set at a position between the minimum allowable transmit power value 1503 and the maximum allowable transmit power value 1502 and at the same time the lower limit threshold 1506 is lower than the average transmit power value 1507 by a predetermined amount. From time t1 to time t2 during which the CPICH reception power value 1504 exceeds the first threshold 1501, the upper limit threshold 1505 and lower limit threshold 1506 are not set. Through in the other time period from time t1 to time t2, transmit power control by the limit section 802, the transmit power value is set to the range between the upper limit threshold 1505 and the lower limit threshold 1506. On the other hand, in the time period from t1 to t2, transmit power control by the limit section 802 is disabled, and therefore the transmit power value is set to the range between maximum allowable transmit power value 1502 and the minimum allowable transmit power value 1503.

In FIG. 15, a dotted line 1510 shows a case where the transmit power value 1508 decided by the transmit power value decision section 104 exceeds the upper limit threshold 1505 or falls below the lower limit threshold 1506 before time t1 and from time t2 onward. A solid line 1509 shows a case where the transmit power value 1508 decided by the transmit power value decision section 104 changes within the range between the upper limit threshold 1505 and the lower limit threshold 1506 before time t1 and from time t2 onward and the transmit power value 1508 decided by the transmit power value decision section 104 changes within the range between the maximum allowable transmit power value 1502 and the minimum allowable transmit power value 1503 from time t1 to time t2. Before time t1 and from time t2 onward, the transmit power value 1508 is set to the upper limit threshold 1505 when it is equal to or higher than the upper limit threshold 1505 (dotted line 1510 in FIG. 15) and set to the lower limit threshold 1506 when it is equal to or lower than the lower limit threshold 1506 (dotted line 1510 in FIG. 15). Furthermore, from time t1 to time t2, the transmit power value 1508 is set to the maximum allowable transmit power value 1502 when it is equal to or higher than the maximum allowable transmit power value 1502 and set to the minimum allowable transmit power value 1503 when it is equal to or lower than the minimum allowable transmit power value 1503.

Then, the operation of the limit section 802 in the above-described configuration will be explained using FIG. 8, FIG. 14 and FIG. 15.

The comparator 1402, which is fed the first threshold 1501 set in the threshold setting section 1401 and CPICH reception power value 1504 compares the first threshold 1501 with the CPICH reception power value 1504 and outputs the comparison result to the selector 1404 and selector 1406. As the result of the comparison at the comparator 1402, if the CPICH reception power value 1504 is lower than the first threshold 1501, of the upper limit threshold 1505 output from the adder 203 and the maximum allowable transmit power value 1502 output from the maximum allowable transmit power value setting section 1403 input to the selector 1404, the selector 1404 selects the upper limit threshold 1505 and outputs the upper limit threshold 1505 to the comparator 205 and the comparator 205 compares the upper limit threshold 1505 with the transmit power value input from the transmit power value decision section 104. On the other hand, of the lower limit threshold 1506 output from the subtractor 204 and the minimum allowable transmit power value 1503 output from the minimum allowable transmit power value setting section 1405 input to the selector 1406, the selector 1406 selects the lower limit threshold 1506, outputs the lower limit threshold 1506 to the comparator 206 and the comparator 206 compares the lower limit threshold 1506 with the output value of the comparator 205.

On the other hand, as a result of the comparison at the comparator 1402, if the CPICH reception power value 1504 is equal to or higher than the first threshold 1501, of the upper limit threshold 1505 output from the adder 203 and the maximum allowable transmit power value 1502 output from the maximum allowable transmit power value setting section 1403 input to the selector 1404, the selector 1404 selects the maximum allowable transmit power value 1502 and outputs the maximum allowable transmit power value 1502 to the comparator 205 and the comparator 205 compares the maximum allowable transmit power value 1502 with the transmit power value input from the transmit power value decision section 104. On the other hand, of the lower limit threshold 1506 output from the subtractor 204 and the minimum allowable transmit power value 1503 output from the minimum allowable transmit power value setting section 1405 input to the selector 1406, the selector 1406 selects the lower limit threshold 1506, outputs the lower limit threshold 1506 to the comparator 206 and the comparator 206 compares the lower limit threshold 1506 with the output value of the comparator 205. The rest of the operation is the same as that in Embodiment 1 above and explanations thereof will be omitted.

Thus, in addition to the effect of Embodiment 1 above, when the CPICH reception power value 1504 is equal to or higher than a threshold, this embodiment does not set the upper limit threshold 1505 or lower limit threshold 1506 and places no restriction on the transmit power even if the transmit power value varies in a range not higher than the maximum allowable transmit power value 1502 and not lower than the minimum allowable transmit power value 1503, and can thereby perform transmission with transmit power suitable for the communication environment when the communication environment is good and can prevent the transmit power from continuing to drop down to the minimum allowable transmit power value 1503 when the communication environment deteriorates and the transmit power should originally be increased due to reception of a wrong signal and there by perform appropriate transmit power control.

This embodiment compares the maximum allowable transmit power value 1502 and minimum allowable transmit power value 1503 with the transmit power when the CPICH reception power value 1504 is equal to or higher than the first threshold 1501, but the present invention is not limited to this and the same effect can be obtained when the present invention is adapted so as to compare the upper limit threshold 1505 and lower limit threshold 1506 with the transmit power when the CPICH reception power value 1504 is the same as the first threshold 1501.

### Embodiment 7

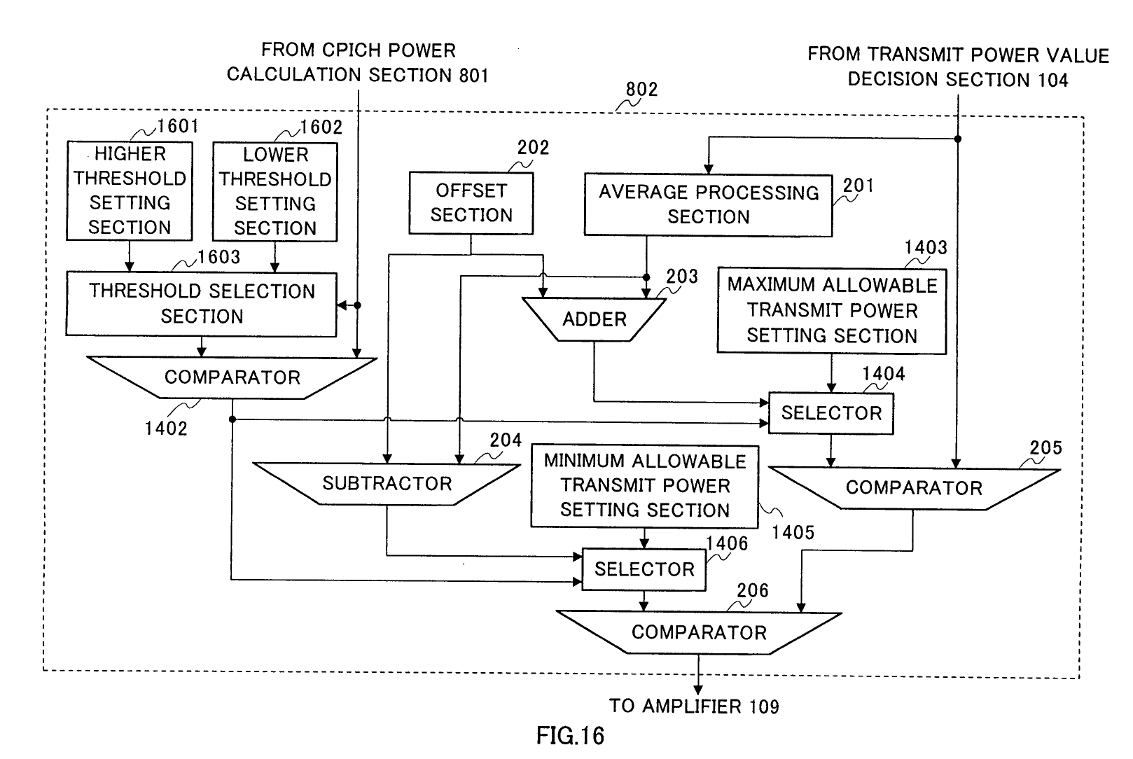

FIG. 16 is a block diagram showing a configuration of a limit section 802 according to Embodiment 7 of the present invention. This embodiment in FIG. 16 differs from FIG. 14 in the configuration including a higher threshold setting section 1601, a lower threshold setting section 1602 and a threshold selection section 1603 and the rest of the components are the same as those in FIG. 14 and therefore those components are assigned the same reference numerals and explanations thereof will be omitted. Furthermore, the configuration of the data transmission apparatus is the same as the configuration in FIG. 1 and explanations thereof will be omitted. Moreover, the operation of the data transmission apparatus other than that of the limit section 802 is the same as that in Embodiment 4 and explanations thereof will be omitted.

The higher threshold setting section 1601 sets a higher threshold which is a second threshold and outputs the set higher threshold to the threshold selection section 1603.

The lower threshold setting section 1602 sets a lower threshold which is a third threshold and outputs the set lower threshold to the threshold selection section 1603.

The threshold selection section 1603 compares the higher threshold input from the higher threshold setting section 1601 and the lower threshold input from the lower threshold setting section 1602 with the CPICH reception power value 1703. When the CPICH reception power value 1703 input from the CPICH power calculation section 801 to the threshold selection section 1603 is equal to or higher than the higher threshold, the threshold selection section 1603 outputs the lower threshold to the comparator 1402 and when the CPICH reception power value 1703 input from the CPICH power calculation section 801 to the threshold selection section 1603 is lower than the lower threshold, the threshold selection section 1603 outputs the higher threshold to the comparator 1402.

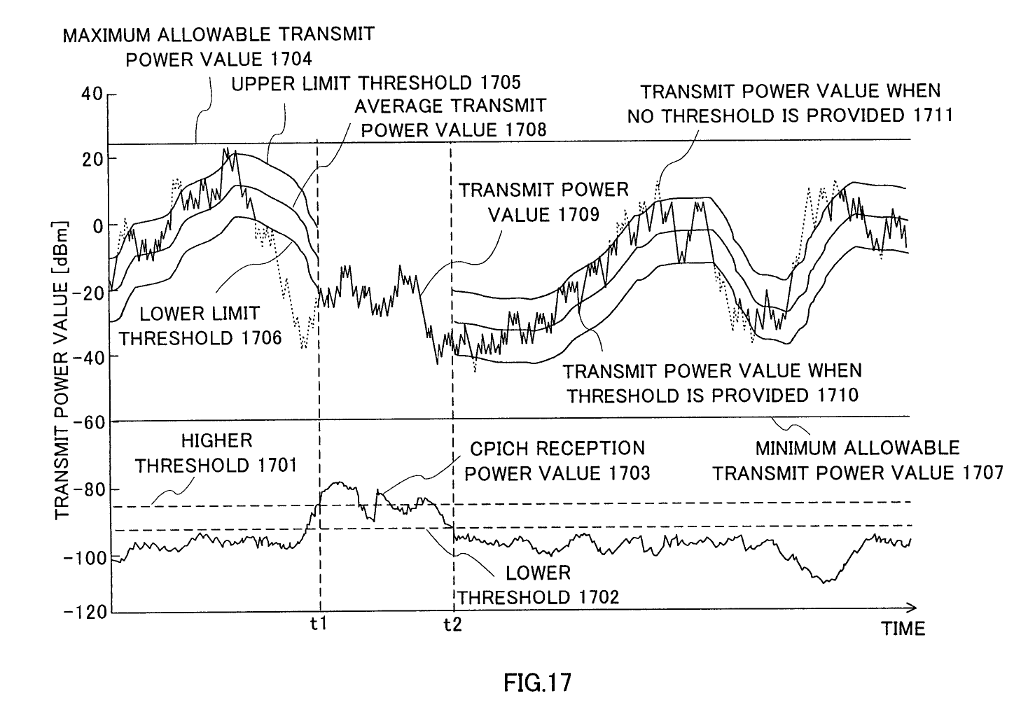

Then, the relationship between the transmit power value, the upper limit threshold and lower limit threshold will be explained using FIG. 17. FIG. 17 shows a time variation of a transmit power value. The average transmit power value 1708 is obtained from the transmit power value 1709.

When the transmit power value 1709 exceeds the upper limit threshold 1705, the upper limit threshold 1705 using the transmit power value, and then the average transmit power value 1708 is calculated by the transmit power value determined at the transmit power value decision section 104. When the transmit power value 1709 falls below the lower limit threshold 1706, the lower limit threshold using the transmit power, and then the average transmit power value 1708 is calculated by the transmit power value determined by the transmit power value decision section 104. Therefore, the average transmit power value 1708 varies in the range between the maximum allowable transmit power value 1704 and the minimum allowable transmit power value 1707 and never exceeds the maximum allowable transmit power value 1704 or falls below the minimum allowable transmit power value 1707.

The upper limit threshold 1705 is set at a position between the minimum allowable transmit power value 1707 and the maximum allowable transmit power value 1704 and at the same time the upper limit threshold 1705 is higher than the average transmit power value 1708 by a predetermined amount. Furthermore, the lower limit threshold 1706 is set at a position between the minimum allowable transmit power value 1707 and the maximum allowable transmit power value 1704 and at the same time the lower limit threshold 1706 is lower than the average transmit power value 1708 by a predetermined amount. From time t1 to time t2 during which the CPICH reception power value 1703 exceeds the higher threshold 1701 until it falls below the lower threshold 1702, the upper limit threshold 1705 and lower limit threshold 1706 are not set. Through in the other time period from time t1 to time t2, transmit power control by the limit section 802, the transmit power value is set to the range between the upper limit threshold 1705 and the lower limit threshold 1706. On the other hand, during a time from t1 to t2, transmit power control by the limit section 802 is disabled, and therefore the transmit power value is set to the range between the minimum allowable transmit power value 1707 and the maximum allowable transmit power value 1704.

In FIG. 17, a dotted line 1711 shows a case where the transmit power value 1709 decided by the transmit power value decision section 104 exceeds the upper limit threshold 1705 or falls below the lower limit threshold 1706 before time t1 and from time t2 onward. A solid line 1710 shows a case where the transmit power value 1709 decided by the transmit power value decision section 104 changes within the range between the upper limit threshold 1705 and the lower limit threshold 1706 before time t1 and from time t2 onward and the transmit power value 1709 decided by the transmit power value decision section 104 changes within the range between the maximum allowable transmit power value 1704 and the minimum allowable transmit power value 1707 from time t1 to time t2. Before time t1 and from time t2 onward, the transmit power value 1709 is set to the upper limit threshold 1705 when it is equal to or higher than the upper limit threshold 1705 (dotted line 1711 in FIG. 17) and set to the lower limit threshold 1706 when it is equal to or lower than the lower limit threshold 1706 (dotted line 1711 in FIG. 17). Furthermore, from time t1 to time t2, the transmit power value 1709 is set to the maximum allowable transmit power value 1704 when it is equal to or higher than the maximum allowable transmit power value 1704 and set to the minimum allowable transmit power value 1707 when it is lower than the minimum allowable transmit power value 1707.

Then, the operation of the limit section 802 in the above described configuration will be explained using FIG. 8 and FIG. 16 to FIG. 18. First, a case where the CPICH reception power value 1703 increases from a value lower than the lower threshold 1702 to the higher threshold 1701 or higher will be explained. In this case, the threshold selection section 1603 selects the higher threshold 1701 and outputs it to the comparator 1402. The higher threshold 1701 input from the higher threshold setting section 1601 to the threshold selection section 1603 is compared by the threshold selection section 1603 with the CPICH reception power value 1703 input from the CPICH calculation section 801 to the threshold selection section 1603.

Since the CPICH reception power value 1703 becomes the higher threshold 1701 or higher at time t1, the threshold selection section 1603 outputs the lower threshold 1702 input from the lower threshold setting section 1602 to the comparator 1402, the comparator 1402 compares the CPICH reception power value 1703 with the lower threshold 1702. When the CPICH reception power value 1703 is equal to or lower than the lower threshold 1702, the selector 1404 and selector 1406 select the lower limit threshold 1706 and upper limit threshold 1705. When the CPICH reception power value 1703 is higher than the lower threshold 1702, the selector 1406 and selector 1404 select the minimum allowable transmit power value 1707 and maximum allowable transmit power value 1704. Since the limit section 802 has selected the lower threshold 1702 in this condition, the selector 1406 does not select the lower limit threshold 1706 unless the CPICH reception power value 1703 falls below the lower threshold 1702. Therefore, from time t1 to time t2, the CPICH reception power value 1703 increases or decreases, repeating the case where it becomes equal to or higher than the higher threshold 1701 and the case where it becomes equal to or lower than the higher threshold 1701, but the maximum allowable transmit power value 1704 and the upper limit threshold 1705, and the minimum allowable transmit power value 1707 and the lower limit threshold 1706 never alternate in a short time.

At time t2, since the CPICH reception power value 1703 falls below the lower threshold 1702, the threshold selection section 1603 selects the higher threshold 1701 input from the higher threshold setting section 1601 and outputs it to the comparator 1402.

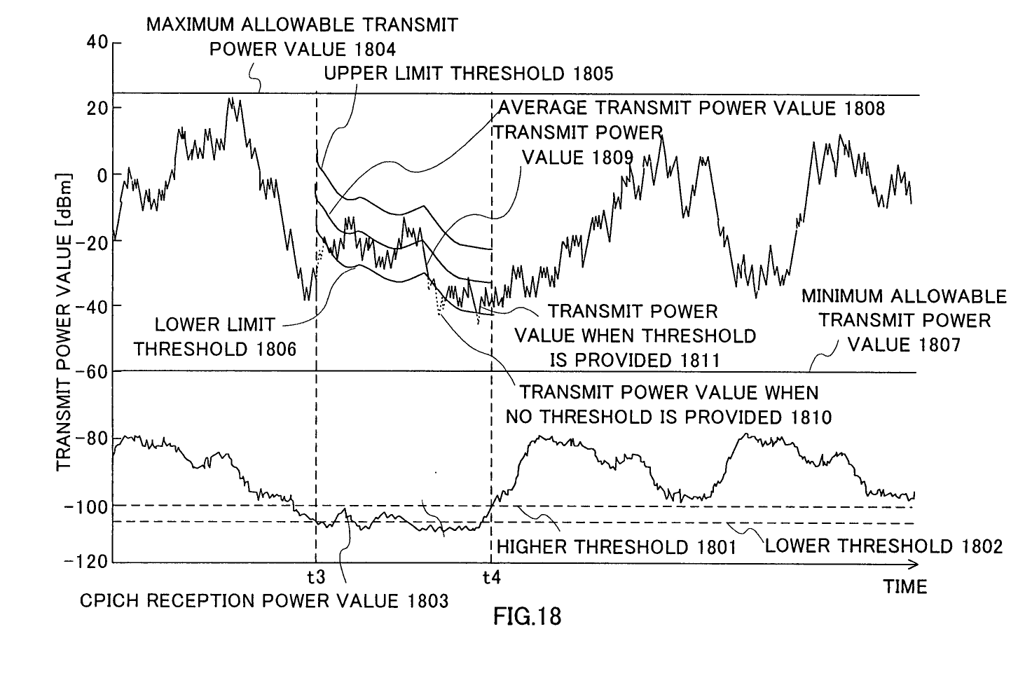

Then, the case where the CPICH reception power value 1803 decreases from the higher threshold to a value below the lower threshold will be explained using FIG. 18. FIG. 18 shows a time variation of a transmit power value. The average transmit power value 1808 is obtained from the transmit power value 1809. When the transmit power value 1809 exceeds the upper limit threshold 1805, the upper limit threshold 1805 using the transmit power value, and then the average transmit power value 1808 is calculated by the transmit power value determined at the transmit power value decision section 104. When the transmit power value 1809 falls below the lower limit threshold 1806, the lower limit threshold using the transmit power, and then the average transmit power value 1808 is calculated by the transmit power value determined by the transmit power value decision section 104. Therefore, the average transmit power value 1808 varies in the range between the maximum allowable transmit power value 1804 and the minimum allowable transmit power value 1807 and never exceeds the maximum allowable transmit power value 1804 or falls below the minimum allowable transmit power value 1807.

The upper limit threshold 1805 is set at a position between the minimum allowable transmit power value 1807 and the maximum allowable transmit power value 1804 and at the same time the upper limit threshold 1805 is higher than the average transmit power value 1808 by a predetermined amount. Furthermore, the lower limit threshold 1806 is set at a position between the minimum allowable transmit power value 1807 and the maximum allowable transmit power value 1804 and at the same time the lower limit threshold 1806 is lower than the average transmit power value 1808 by a predetermined amount.

In FIG. 18, a dotted line 1810 shows a case where the transmit power value 1809 decided by the transmit power value decision section 104 exceeds the upper limit threshold 1805 or falls below the lower limit threshold 1806 from time t3 to time t4. A solid line 1811 shows a case where the transmit power value 1809 decided by the transmit power value decision section 104 changes within the range between the upper limit threshold 1805 and the lower limit threshold 1806 from time t3 to time t4, and a case where the transmit power value 1809 decided by the transmit power value decision section 104 changes within the range between the maximum allowable transmit power value 1804 and the minimum allowable transmit power value 1807 before time t3 and from time t4 onward. From time t3 to time t4, the transmit power value 1809 is set to the upper limit threshold 1805 when it is equal to or higher than the upper limit threshold 1805 (dotted line 1810 in FIG. 18) and set to the lower limit threshold 1806 when it is equal to or lower than the lower limit threshold 1806 (dotted line 1810 in FIG. 18). Furthermore, before time t3 and from time t4 onward, the transmit power value 1809 is set to the maximum allowable transmit power value 1804 when it is equal to or higher than the maximum allowable transmit power value 1804 and set to the minimum allowable transmit power value 1807 when it is lower than the minimum allowable transmit power value 1807.

For any time other than a time period from time t3 when the CPICH reception power value 1803 falls below the lower threshold 1802 to time t4 when it falls below the higher threshold 1801, neither of the upper limit threshold 1805 and lower limit threshold 1806 is set. Through in the time period from time t3 to time t4,the transmit power control by the limit section 802, the transmit power value set to the range between, the upper limit threshold 1805 and the lower limit threshold 1806 On the other hand, for any time other than the time period from time t3 to time t4, the transmit power control by the limit section 802 is disabled, the transmit power value set to the range between the maximum allowable transmit power value 1804 and the minimum allowable transmit power value 1807.

Before time t3, the threshold selection section 1603 selects the lower threshold 1802 and outputs it to the comparator 1402. The lower threshold 1802 input from the lower threshold setting section 1602 to the threshold selection section 1603 is compared by the threshold selection section 1603 with the CPICH reception power value 1803 input from the CPICH power calculation section 801 to the threshold selection section 1603.

At time t3, the CPICH reception power value 1803 falls below the lower threshold 1802, and therefore the threshold selection section 1603 outputs the higher threshold 1801 input from the higher threshold setting section 1601 to the comparator 1402 and the comparator 1402 compares the CPICH reception power value 1803 with the higher threshold 1801. When the CPICH reception power value 1803 is lower than the higher threshold 1801, the selector 1404 and selector 1406 select the upper limit threshold 1805 and lower limit threshold 1806 and when the CPICH reception power value 1803 is equal to or higher than the higher threshold 1801, the selector 1406 and selector 1404 select the minimum allowable transmit power value 1807 and maximum allowable transmit power value 1804. Therefore, unless the CPICH reception power value 1803 exceeds the higher threshold 1801, the selector 1406 and selector 1404 do not select the lower limit threshold 1806 and upper limit threshold 1805, and therefore from time t3 to time t4, the CPICH reception power value 1803 repeatedly shows values equal to or higher than the lower threshold 1802 or equal to or lower than the lower threshold 1802, but the maximum allowable transmit power value 1804 and the upper limit threshold 1805, and the minimum allowable transmit power value 1807 and the lower limit threshold 1806 never alternate in a short time.

At time t4, the CPICH reception power value 1803 exceeds the higher threshold 1801, and therefore the threshold selection section 1603 selects the lower threshold 1802 input from the lower threshold setting section 1602 and outputs it to the comparator 1402. Unless the CPICH reception power value 1803 increases from a value below the lower threshold 1802 to a value equal to or higher than the higher threshold 1801 or decreases from a value equal to or higher threshold 1801 to a value below the lower threshold 1802, the currently selected higher threshold 1801 or lower threshold 1802 is kept as is. The rest of the operation is the same as that of Embodiment 1 and Embodiment 6 described above and explanations thereof will be omitted.

When the CPICH reception power values 1703 and 1803 are the same as the higher thresholds 1701 and 1801 or lower thresholds 1702 and 1802, this embodiment may also be adapted so as not switch from the higher thresholds 1701 and 1801 to the lower thresholds 1702 and 1802 or switch from the lower thresholds 1702 and 1802 to the higher thresholds 1701 and 1801 to obtain the same effect.

In addition to the effect of Embodiment 6 above, this embodiment selects the lower thresholds 1702 and 1802 when the CPICH reception power values 1703 and 1803 exceed the higher thresholds 1701 and 1801 and selects the higher thresholds 1701 and 1801 when the CPICH reception power values 1703 and 1803 fall below the lower thresholds 1702 and 1802, and therefore when the CPICH reception power values 1703 and 1803 increase to the higher thresholds 1701 and 1801 or decrease to the lower thresholds 1702 and 1802 in a short time, it is possible to prevent the upper limit thresholds 1705 and 1805 and the maximum allowable transmit power values 1704 and 1804 or lower limit thresholds 1706 and 1806 and minimum allowable transmit power values 1707 and 1807 from alternating in a short time, making transmit power control unstable.

The data transmission apparatus according to Embodiment 1 to Embodiment 3 and Embodiment 5 is applicable to a base station or mobile station and the data transmission apparatus according to Embodiment 4, Embodiment 6 and Embodiment 7 is applicable to a mobile station apparatus. Furthermore, when the transmit power is the same as the upper limit threshold, lower limit threshold, maximum allowable transmit power value and minimum allowable transmit power value, it is possible to arbitrarily select whether the upper limit threshold, lower limit threshold, maximum allowable transmit power value or minimum allowable transmit power value should be sent as the transmit power value or not irrespective of the descriptions of Embodiment 1 to Embodiment 7.

As described above, the present invention can prevent disconnection of calls and realize stable communications through appropriate transmit power control even when a wrong signal is received due to deterioration of the communication environment.

The present invention is not limited to the above-described embodiments, and various variations and modifications may be possible without departing from the scope of the present invention.

This application is based on the Japanese Patent Application No.2002-146777 filed on May 21, 2002, entire content of which is expressly incorporated by reference herein.

What is claimed is:

1. A data transmission apparatus comprising:
an average transmit power value calculation section that calculates an average value of transmit power for a predetermined time;
a threshold setting section that sets a lower limit threshold between an average value of the transmit power calculated by said average transmit power value calculation section and minimum allowable transmit power value; and
a transmission section that carries out transmission with said transmit power value when the transmit power value is equal to or higher than said lower limit threshold and carries out transmission using said lower limit threshold as the transmit power value when the transmit power value is lower than said lower limit threshold.

2. The data transmission apparatus according to claim 1, wherein said threshold setting section sets an upper limit threshold between an average value of the transmit power calculated by said average transmit power value calculation section and the maximum allowable transmit power value and said transmission section carries out transmission with said transmit power value when the transmit power value is lower than said upper limit threshold and carries out transmission using said upper limit threshold as the transmit power value when the transmit power is equal to or higher than said upper limit threshold.

3. The data transmission apparatus according to claim 2, wherein said threshold setting section offsets the average value of the transmit power and sets said upper limit threshold and said lower limit threshold.

4. The data transmission apparatus according to claim 3, wherein said threshold setting section sets different amounts of offset between said upper limit threshold and said lower limit threshold.

5. The data transmission apparatus according to claim 2, wherein said threshold setting section makes said upper limit threshold and said lower limit threshold changeable between an initial power value and a final power value closer to the average value of the transmit power than said initial power value, sets said upper limit threshold and said lower limit threshold to said initial power value when a reset signal is input to said threshold setting section and changes said upper limit threshold and said lower limit threshold from said initial power value to said final power value every time the transmit power value is changed until said reset signal is input to said threshold setting section.

6. The data transmission apparatus according to claim 1, further comprising a power value calculation section that calculates a CPICH power value, wherein said average transmit power value calculation section comprises a storage section that stores an average value of the calculated transmit power and an optimum average transmit power value calculation section that adds up the average value of the transmit power stored in said storage section and the average value of the calculated transmit power at a predetermined ratio to obtain an optimum average transmit power value, and said optimum average transmit power value calculation section calculates an optimum average transmit power value by increasing the ratio of the average value of the transmit power stored in said storage section as the CPICH power value calculated by said power value calculation section decreases and calculates an optimum average transmit power value by decreasing the ratio of the average value of the transmit power stored in said storage section as the CPICH power value calculated by said power value calculation section increases.

7. The data transmission apparatus according to claim 2, further comprising a power value calculation section that calculates a CPICH power value, wherein said threshold setting section sets said maximum allowable transmit power value and said minimum allowable transmit power value when the CPICH power value calculated by said power value calculation section is equal to or higher than a first threshold and sets said upper limit threshold and said lower limit threshold when the CPICH power value calculated by said power value calculation section is lower than the first threshold.

8. The data transmission apparatus according to claim 7, wherein said threshold setting section comprises a selection section that selects, when the CPICH power value exceeds a second threshold, a third threshold which is lower than said second threshold as said first threshold and selects, when the CPICH power value falls below said third threshold, said second threshold as said first threshold.

9. A base station apparatus provided with a data transmission apparatus, said data transmission apparatus comprising:
an average transmit power value calculation section that calculates an average value of transmit power for a predetermined time;
a threshold setting section that sets a lower limit threshold between an average value of the transmit power calculated by said average transmit power value calculation section and minimum allowable transmit power value; and
a transmission section that carries out transmission with said transmit power value when the transmit power value is equal to or higher than said lower limit threshold and carries out transmission using said lower limit threshold as the transmit power value when the transmit power value is lower than said lower limit threshold.

10. A communication terminal apparatus provided with a data transmission apparatus, said data transmission apparatus comprising:
an average transmit power value calculation section that calculates an average value of transmit power for a predetermined time;
a threshold setting section that sets a lower limit threshold between an average value of the transmit power calculated by said average transmit power value calculation section and minimum allowable transmit power value; and
a transmission section that carries out transmission with said transmit power value when the transmit power value is equal to or higher than said lower limit threshold and carries out transmission using said lower limit threshold as the transmit power value when the transmit power value is lower than said lower limit threshold.

11. A data transmission method comprising:
an average transmit power value calculating step of calculating an average value of transmit power;
a threshold setting step of setting a lower limit threshold between an average value of the transmit power and minimum allowable transmit power value and an upper limit threshold between an average value of the transmit power and maximum allowable transmit power value; and
a transmitting step of carrying out transmission with said transmit power value when the transmit power value is equal to or higher than said lower limit threshold and carrying out transmission using said lower limit threshold as the transmit power value when the transmit power value is lower than said lower limit threshold.
